(19) United States
(12) Patent Application Publication
(10) Pub. No.: US 2011/0276452 A1
(43) Pub. Date: Nov. 10, 2011

(54) Procurement and Salvage Auction System

(75) Inventor: Charles M. Stephens, Dania, FL (US)

(73) Assignee: MARINEBIDEXCHANGE.COM, INC., Fort Lauderdale, FL (US)

(21) Appl. No.: 13/187,374

(22) Filed: Jul. 20, 2011

Related U.S. Application Data
(63) Continuation-in-part of application No. 10/126,515, filed on Apr. 22, 2002.
(60) Provisional application No. 60/287,008, filed on Apr. 30, 2001.

(51) Int. Cl. G06Q 40/00

(52) U.S. Cl. 705/35

(57) ABSTRACT

An on-line RFP procurement auction system with bidder sub-auctions for both repair and salvage of damaged property, using a telecommunications network accessible by network members including requesters, repair bidders, and salvage bidders, for processing an RFP for goods and services through at least one server and operating software. The system includes a database for each category of goods and services offered or desired by network members; software for requesters to generate RFPs for goods or services that include photographic and alpha-numeric RFP data; software for transmitting the RFPs to the server; capacity for e-mail and wireless distribution of RFP notices to bidders who have requested notices within selectable categories of RFP's; capacity to enable a repair bidder to submit an encrypted bid to the server; and capacity within the server for generating a list of all responsive bids and e-mailing the same to the requester after conclusion of an auction.

### CROSS-REFERENCE TO RELATED APPLICATION

This application is a continuation-in-part application of and claims priority from U.S. nonprovisional patent application Ser. No. 10/126,515 filed on Apr. 22, 2002. The foregoing application is incorporated in its entirety herein by this reference.

### FIELD OF THE INVENTION

The system relates to decisions to repair or salvage damaged property made by insurers, government agencies, or property owners. More specifically, the invention relates to online systems and methods for simultaneously conducting a procurement auction and a salvage bid auction to assist an insurer, government agency, or property owner in determining whether to pay to repair damaged property or to sell the damaged property for salvage.

### BACKGROUND

On-line or Internet based auctions have become popular in recent years and, as such, have become an integral aspect of electronic or e-commerce as it is known today. Such auctions are technically known as forward auctions or highest bid wins auctions. Although the various hardware, software, and Internet means for effecting such forward or high-bid auctions may differ, the objective is always the same, that is, to solicit the highest possible offer for the particular goods or product that is the subject of the auction.

Less common are auctions of services, in that services do not as readily lend themselves to e-commerce, this for a number of reasons, including the personalized nature of most services, even where the object of the service is an inanimate object, e.g., as in the repair of a yacht or mobile home or the renovation of a warehouse to code or Chinese drywall repairs in a home. Accordingly, the development of e-commerce relative to services has been largely informational in character, with actual transactions rarely occurring. Yet less common in contemporary e-commerce is the so-called RFP (i.e., request for proposal), quotation, or procurement auction in which it is the buyer, not the seller, that initiates the auction process and in which the sellers that compete with each other. This is also known as a low-bid wins auction. Clearly, the development of low bid auctions is in the interest of the public. The instant invention, while capable of forward auction functions, as is described herein, is primarily directed to RFP auctions for services in which bids are solicited for the rendering of particular services within a given industry in response to a request for proposal (“RFP”).

Although the present system, as described herein, is the result of needs of the marine industry and cargo transportation industry, and more specifically marine insurance companies soliciting competitive bids for vessel and cargo repair in what heretofore has been essentially a closed noncompetitive procurement process. The principles of the invention are applicable to substantially any business having recurrent needs for particular types of goods and services as a part of a procurement process. That is, buyers in need of goods or services often spend considerable time in the location of an appropriate vendor. Buyers, known as purchasing agents in larger companies, may employ trade publications, directories, recommendations and other means to locate prospective vendors. Conversely, vendors may advertise through various media and, in the case of goods, by direct sales methods to make known to potential buyers the existence of their goods and services, and how to contact them.

When a prospective buyer identifies a group of qualified vendors, each must be contacted to obtain a product or service price, as well product as availability, delivery time and other information. This is of course a time consuming process in which companies will, where necessary, rely on experienced purchasing agents to accomplish the same. However, in certain situations, as are commonplace in the marine cargo and other businesses, the need for a given product or service may be particularly time sensitive, this because of geographical factors, limited number of qualified vendors and, in the case of a damaged vessel, the impracticality of moving the vessel out of the boatyard or dockage at which it is located. Likewise, perishable cargo has a short shelf life and therefore requires timely bids for purchase or repair. Accordingly, persons and companies requiring services in connection with damaged vessel and cargo and insurers thereof often find themselves with few options with respect to marine surveyors and adjusters, on the one hand, and boatyards, shipyards, cargo salvors, and their subcontractors on the other hand.

While the primary need for such procurement of services arises in the area of marine insurance and warranty work for boat and marine engine manufacturers (the so-called business-to-business, or B2B, e-commerce) there, as well, exist significant needs on the part of private boat owners having uninsured needs, such as repair, re-fits, re-painting, re-powering.

In some on-line systems for generating RFPs, filtering of RFPs such that sets of a priori conditions must be met by a prospective bidder before the bid process can commence. In distinction, the present system relies upon a combination of network membership and information secured through membership registration in order to determine subsets of prospective bidders meeting one or more of particular requirements or parameters of a particular RFP network buyer/requester, or the network itself, this including, for example, such factors as geography, capability, experience, peril classification, language spoken and conditions of sale or offer. RFP bidder evaluation of this level of sophistication cannot be obtained through conventional systems.

In the property and casualty insurance industries, adjusters for the insurance companies are currently able to estimate the covered cost to repair damaged property with little or no accountability for their estimates. As a result, some adjusters engage in fraud to inflate repair cost estimates while receiving illegal kickbacks from repair bidders, thereby incurring additional unnecessary expenses for insurers in operating costs and policy holders in the form of higher premiums. Although insurance fraud is rife in the industry, previously, automated electronic systems and methods have not existed to assist in reducing or eliminating such fraud. As a result, policy holders have endured massive increases in premiums paid to insurers who pass on their fraud-related losses to their insured policy holders.

Because adjusters do not repair damaged property, their involvement in determining the amount to be paid for repairs, rather than obtaining a lowest possible bid from a plurality of contractors, allows some unscrupulous adjusters and bidders to game the insurance system due to the lack of open and transparent bidding.

A need exists for an on-line bid, quote, or RFP system having narrative comments by each contractor on each work topic so as to exceptions or clarifications to be considered by the requester. A need also exists for an online electronic auction system, which is capable of conducting both forward auctions and reverse auctions, that permits persons interested in the property (e.g., property owners, lessees, government agencies, or insurers) to obtain repair and salvage bids directly from contractors rather than permitting adjusters to determine who is selected as the contractor to perform the job and how much that contractor is paid, thereby reducing or eliminating fraud by adjusters and bidders providing bids higher than necessary for repairs.

### SUMMARY

An on-line RFP procurement auction system is described for both repair and salvage of damaged property, using a telecommunications network accessible by network members including requesters, repair bidders, and salvage bidders, for processing an RFP for goods and services through at least one server and operating software. Rather than being a buyer/vendor network lacking hardware, the present system, in distinction, uses a server to accomplish the many benefits as are more fully set forth below. The auction system can include bidder sub-auctions. The system can include a database for each category of goods and services offered or desired by network members; software for requesters to generate RFPs for goods or services that include photographic and alpha-numeric RFP data. The system can also include software for transmitting the RFPs to the server. The system can have capability for e-mail and wireless distribution of RFP notices to bidders who have requested notices within selectable categories of RFP's. The system can also have capability to enable a repair bidder to submit an encrypted bid to the server. The system can further include capability within the server for generating a list of all responsive bids and e-mailing the same to the requester after conclusion of an auction.

The system is facilitated through a database having partitions inclusive of registration form data, a service provider data, categories of goods and services data for high bid auctions, bidding sub-contractors data and links to seller/bidder profile mini-web pages including jpegs and profiles thereof. The system further includes many elective pop-up tutorials to assist new users throughout the different phases as well as an automated e-mail invoicing system for charging of commissions to network buyers/requesters of RFP auctions predicated upon the lowest received bid, even if such bid is not the bid selected by the ultimate network buyer/requester. The system also provides automated e-mail start and finish notifications to the buyer/requester standard or custom buyer/requester messages notifying the best candidate of its selection and the losing bidder notifications

The system permits the inclusion of information critical to the individual RFP, even if the template tailored for a given industry does not anticipate that information. For example, if the most important information to an RFP is contained in a naval architect's report, an electrician's report, or a list of unique storage requirements, the buyer customer can append those reports in PDF format, and each bidder may view those reports by clicking a link within the RFP to access the information.

The systems and methods described herein provide numerous advantages to buyers (e.g., property owners, property lessees, and insurance carriers) as well as to sellers of services (e.g., repair bidders and salvage bidders, which can include both contractors and subcontractors). For example, the systems and methods described herein have one advantage in providing electronic commerce particularly adapted to the solicitation of bids for the procurement of goods and services by a prospective buyer (RFP requester) from a subset of prospective network sellers/bidders.

Another advantage of the systems and methods described herein is their particular application to companies or individuals, such as insurance companies, private boat owners, private and commercial waterfront owners, marinas, municipal beach and lake restoration, and vessel manufacturers having warranty service requirements relative to marine related products and services.

Still another advantage of the systems and methods described herein is their enablement of companies and individuals that sell marine related products or services, such as boatyards and shipyards, marine repair facilities, engine and equipment dealers, boat trailer manufacturers, boat towing companies, boat transporting companies, dredging companies, dock and sea wall companies, and beach restoration companies, to increase the size of their potential markets and to impart a higher degree of professionalism to their respective businesses while repairing and rebuilding damaged property.

Yet another advantage of the systems and methods described herein is their usage in providing expedited disaster relief. For example, after a natural disaster, insurance personnel can quickly and seamlessly upload, via a satellite connection or other communications network, bidding parameters for residential or commercial property repair, thereby permitting bidding within hours of property damage and eliminating the traditional chaos that occurs when contractors roam uncoordinated through disaster zones seeking repair jobs.

Another advantage of the systems and methods described herein is that, by expediting the building process, insurance carriers benefit from expedited job completion, which results in reduced rental reimbursements where the carrier might otherwise have to provide and pay for a rental property of the same type as the damaged property until the damaged property can be repaired.

Still another advantage of the systems and methods described herein is that reverse RFP (or procurement) auctions for repair of damaged property can be conducted simultaneously with forward salvage auctions for the salvage, or sale, of damaged property so that a buyer of services can obtain the lowest bid for the desired repair services rather than the usual circumstances in which sellers of repair services seek to obtain work at the highest possible bid as well as the highest bid for the sale of the damaged property to a salvor. The competing repair bids and salvage bids can be analyzed by the system's software to determine or to provide a recommendation as to whether the damaged property is more profitably repaired or sold for salvage based on an automated comparison of the costs of the repairs and other factors (e.g., its post-repair value) and the value of the damaged property if sold. Reverse auctions, as conducted using the systems and methods herein, are particularly useful for ensuring that the lowest possible competitive bid is obtained for technically complex and unique repair services.

Yet another advantage of the systems and methods described herein is that use of the system and methods reduce the amount of fraud and collusion between property owners, adjusters, and contractors, thereby reducing losses in the insurance industry while ensuring that property is repaired or salvaged at a fair price so that insurance premiums for policy holders are not increased to cover losses attributable to insurance fraud.

Yet another advantage of the systems and methods described herein is that use of the system and methods permit electronic repair and salvage auctions to be conducted on a proxy basis by the system on the bidder's behalf so that the bidder can bid in an auction based on preset maximum bid amounts and maximum bid increment increases without being present online to monitor and bid in the auction where the bidder is unavailable at the scheduled auction time or where the bidder experiences a loss or disruption of power or Internet service or computer failure during the auction.

Accordingly, the invention features an automated auction system. The automated auction system can include a network server communicatively connected to a telecommunications network and electronic procurement auction software and electronic forward auction software installed on the server. The electronic procurement auction software program can electronically receive a request for proposal (RFP) submitted over the telecommunications network by a requester to solicit a plurality of bids from repair bidders for repair of a damaged property and to electronically receive bids submitted over the telecommunications network by at least one repair bidder. Each repair bidder's bid can be the repair bidder's price to repair the damaged property. The server can conduct the electronic procurement auction software and electronic forward auction software concurrently. The electronic forward auction software program electronically receives bids submitted over the telecommunications network by a plurality of salvage bidders in response to an offer to sell the damaged property that is electronically submitted over the communications network by the requester. The system further includes software installed on the server for comparing results of the electronic procurement auction and the electronic forward auction to make an automated recommendation that is presented to the requester concerning whether the damaged property is more valuable if repaired or if sold for salvage value.

In another aspect, the invention can feature the server further including an operating software and at least one database accessible via the telecommunications network, which contains data related to the requesters, repair bidders, and salvage bidders.

In another aspect, the invention can feature the damaged property being a vessel, cargo, house, building, mobile home, crane, a rock crusher, water and sewage treatment plant, or any other real or personal property that can be repaired if damaged.

In another aspect, the invention can feature the system further including a database installed on the server and accessible via the telecommunications network. The database can feature information related to each category of services offered or desired by registered network members of the system. The registered network members of the system can include requesters, repair bidders, and salvage bidders;

In another aspect, the invention can feature the system further including graphic upload software installed on the server and accessible via the telecommunications network for remote use by requesters to particularly illustrate and explain desired RFP requirements.

In another aspect, the invention can feature the system further including software enabling network buyers to generate RFPs for services. The software can be installed on the server and accessible via the telecommunications network, and can feature a preview module for use during an RFP pending period preceding an active RFP allowing RFPs to be previewed by requesters or bidders. Each RFP can include at least one uploaded image and alpha-numeric data.

In another aspect, the invention can feature the system further including software for transmitting said RFPs to said server via the telecommunications network.

In another aspect, the invention can feature the system further including software for e-mail and wireless distribution via the telecommunications network of RFP notices to those bidders that have asked for notices within selectable categories of RFPs.

In another aspect, the invention can feature the system further including software for enabling a bidder to submit an encrypted bid via the telecommunications network to said server.

In another aspect, the invention can feature the system further including software for displaying all bids and a bidder's optional profile to the requester via the telecommunications network, at a time only after an RFP period has closed, so that a successful bidder may be selected.

In another aspect, the invention can feature the requester's RFP including a first narrative description of property damage and the requester's recommended repairs. The repair bidder's bid in response to the RFP can further include a second narrative description of the repair bidder's recommended repairs if the repair bidder's recommended repairs differ from the requester's recommended repairs. Repair bidders can offer their repair estimate amounts in the narrative comments rather than in the bid amount field to avoid being eliminated in the requester's consideration as a viable bidder.

In another aspect, the invention can feature the server further including software for providing a link to a repair bidder's website, which link is provided with the repair bidder's bid.

In another aspect, the invention can feature the server further including software for furnishing a particular form to a requester via the telecommunications network for use with a particular category of RFP.

In another aspect, the invention can feature the RFP requesting data from each repair bidder, wherein the requested date includes at least one type of data selected from among the following: a written description of property damage, a visual description of property damage, an insurance assessment, a surveyor report, storage costs, repair costs, ship repairs legal liability insurance (“SRLLI”) costs, time to complete the job, sales tax, percentage of total repair for expected supplement, salvage value, property transportation costs, warranty work estimates, salvage value of items, expected weather days, and union strike information.

In another aspect, the invention can feature the server further including software for establishing a member profile through use of a registration questionnaire, wherein member profile information is stored in the at least one database, and wherein the software for establishing a member profile, the registration questionnaire, and the database are accessible on the server via the telecommunications network.

In another aspect, the invention can feature the requester being a member selected from among the following: marine insurance companies, private boat owners, self-insured parties, boat manufacturers, marinas, private and commercial waterfront facilities, homeowners, building owners, mobile home owners, insurers, government agencies, and owners or lessees of any property that is capable of being repaired if damaged.

In another aspect, the invention can feature the repair bidder being a member selected from among the following: boat yards, boat and broker-dealers, vessel trailer manufacturers, vessel towing companies, vessel and cargo salvors, vessel transporting companies, salvors and wreck removers, dock and seawall companies, beach dredging and restoration companies, construction contractors, demolition contractors, mechanics, repair companies, and any other contractor capable of repairing or salvaging damaged property.

In another aspect, the invention can feature the server further including software for charging commissions to requesters for a lowest RFP type bid even if such lowest bid is not selected by said requester.

In another aspect, the invention can feature the server further including software for defining an auction period during which a RFP subject description may be added to, but not deleted, from the database stored on the server and accessible via the telecommunications network.

In another aspect, the invention can feature the server further including software for providing selectable categories of sub-contractor databases comprising information related to network members for use in responding to active RFPs.

In another aspect, the invention can feature the system further including at least one of the following: a repair job fragmentation software module, a warranty segregation software module, a repair segregation software module to separate bidding for repairs not covered by insurance from those covered by insurance, industry-specific software information submission templates, a bid-conflict identification and resolution software module, a cost overrun identification software module, a bidder feedback compilation software module, a timing software module, a pre-assigned bid amount software module, and a proxy bidding software module, wherein these software modules and templates are installed on the server and accessible to requesters and bidders by computer using the system via the telecommunications network.

In another aspect, the invention can feature the server further including software for establishing a limited RFP auction comprising a selectable subset of repair bidders.

In another aspect, the invention can feature the server further including database search software, accessible via the telecommunications network, for identifying candidate bidders for said limited auction.

A method of the invention can be used to submit to a computer system over a network a request for proposal (RFP) related to a cost to repair a damaged property, wherein the RFP is submitted by a requester. In another step of the method, bids can be solicited electronically for repair of the damaged property using the computer system to conduct an automated electronic procurement auction that solicits bids, wherein the bids are solicited from repair bidders in response to the RFP for repair of the damaged property. In another step of the method, bids submitted electronically by repair bidders can be accepted electronically in an automated process. Each bid can include the repair bidder's price to repair the damaged property. In another step of the method, bids can be solicited electronically for the sale of the damaged property using the computer system to conduct an automated electronic forward auction concurrently with the electronic procurement auction. The electronic forward auction electronically can receive salvage bids from salvage bidders submitted through the system's telecommunications network so as to permit the requester to offer to sell the damaged property to the salvage bidder submitting a highest salvage bid. In another step of the method, bids submitted electronically to the computer system through the network by salvage bidders who wish to purchase the damaged property can be electronically accepted by the system. Finally, in another step of the method, the results of the electronic procurement auction and the electronic forward auction can be electronically compiled for comparison to determine whether the damaged property is more valuable if repaired or if sold for salvage value.

Another method of the invention includes the steps of using the computer system: (i) to select a lowest procurement bid submitted by the repair bidders participating in the electronic procurement auction, wherein the lowest procurement bid is less than procurement bids submitted by other repair bidders and a predetermined amount less than the estimated value of the damaged property when repaired minus the highest salvage bid, and wherein the repair bidder submitting the lowest procurement bid is selected to repair the damaged property; and (ii) to select a highest salvage bid submitted by the salvage bidders participating in the electronic forward auction, wherein the highest salvage bid is greater than salvage bids submitted by other salvage bidders and a predetermined amount more than the estimated value of the damaged property when repaired minus the lowest procurement bid, and wherein the salvage bidder submitting the highest salvage bid is selected to purchase the damaged property.

Another method of the invention includes the steps of using the computer system to electronically submit through the network a first narrative description of property damage and the requester's recommended repairs in the requester's RFP and to electronically submit through the network a second narrative description of the repair bidder's recommended repairs in the repair bidder's bid in response to the RFP if the repair bidder's recommended repairs differ from the requester's recommended repairs.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a conceptual illustration of the categories of network members of the present system.

FIG. 2 is a conceptual block diagram showing the ultimate inputs and outputs of the inventive system when employed as a RFP (low bid) auction.

FIG. 3 is a chart that elaborates on the information of FIG. 2.

FIG. 4 is a web page that elaborates on the information of FIG. 2.

FIG. 5 is a state block diagram showing the constituent functions of the system server and its relationship to the database of registration forms, categories of goods, service providers, and elective tutorials for explanation of registration forms, bid forms, RFPs, and other forms.

FIG. 6 is a system flow diagram showing the relationship of the various functions of the system of FIG. 5, databases thereof, and relationships therebetween.

FIGS. 7 through 12 are bidder response web pages for a single RFP.

FIG. 13 is a web page of the system used to generate and post an RFP.

FIG. 14 is a web page used to view an RFP.

FIG. 15 is a web page used by a seller/bidder to limit categories of RFP to be received, to establish a personal e-mail notification of auctions in categories of seller/bidder interest.

FIG. 16 is a page for RFP management.

FIG. 17 is a conceptual flow diagram of the ultimate inputs and outputs of the present system when used as a forward (high bid) auction.

FIG. 18 is a group of forward auction thumbnail photos that may be increased in size for viewing via a clickable zoom feature.

FIG. 19 is a flow diagram of registration and navigation routines applicable to network bidders and insurance company requester.

FIG. 20 is a flow diagram of registration and navigation routines of the program applicable to network members desirous of availing themselves of all capabilities of the instant system.

FIG. 21 is a site map of the system.

FIG. 22 is a FAQ page.

FIG. 23 is a block diagram, with annotations, providing a summary of system capability for B2B and C2B purposes.

FIGS. 24 through 26 show search options of the system.

### DETAILED DESCRIPTION

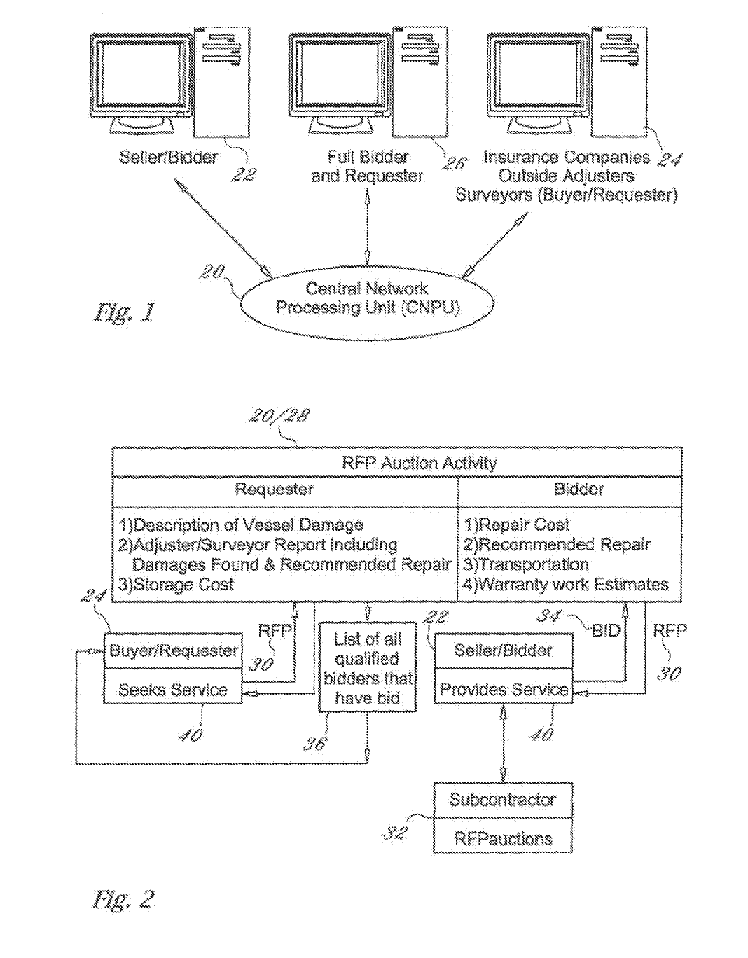

In FIG. 1 is shown the conceptual relationship between a network server 20 of the present invention and the categories of users thereof, namely, a seller/bidders 22, also referred to herein as a network seller/bidder or as a repair bidder, and parties that generate procurement requests (i.e., requests for proposal or RFPs), that is, parties that generate RFPs, such parties herein referred to as a network buyer/requester 24. Between the network member seller/bidder 22 and network member buyer requester 24 are parties 26 who wish to participate in the bidding as well as the requesting side of the instant system. Such parties will typically also participate in conventional high bid auctions, as are more fully set forth below. Therefore, such prospective bidders are termed “full bidders” in the terminology of the instant system. Bidders may submit bids electronically using the system. In some embodiments, a system administrator may charge a fee to bidders submitting bids. In other embodiments, the bidders may submit bids without charge. The system can be used to conduct both forward auctions and reverse auctions electronically.

The RFP can relate to a network buyer/requester's desire to repair, remove, or salvage damaged property either owned, controlled, leased, or regulated by the network buyer/requester. The RFP can also be related to a renovation project for property for which the network buyer/requester is soliciting bids. Damaged property can include a vessel, cargo, house, building, mobile home, crane, a rock crusher, water and sewage treatment plant, or any other real or personal property that can be repaired if damaged. Damaged property might also include a home with Chinese drywall, asbestos, or another health hazard that must be removed from the building and the building renovated.

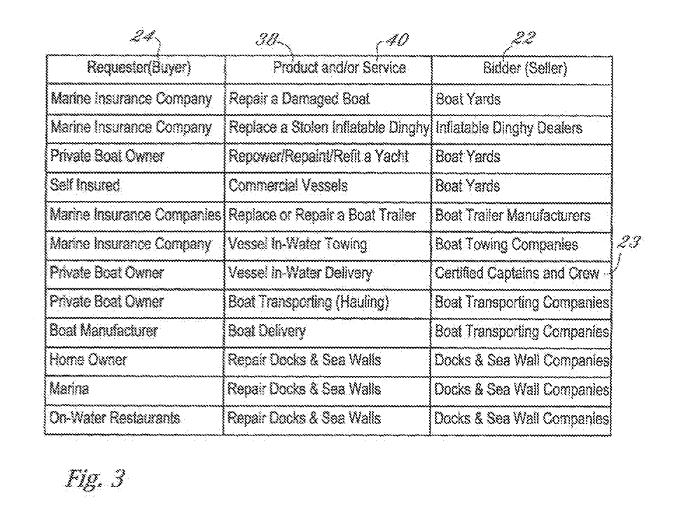

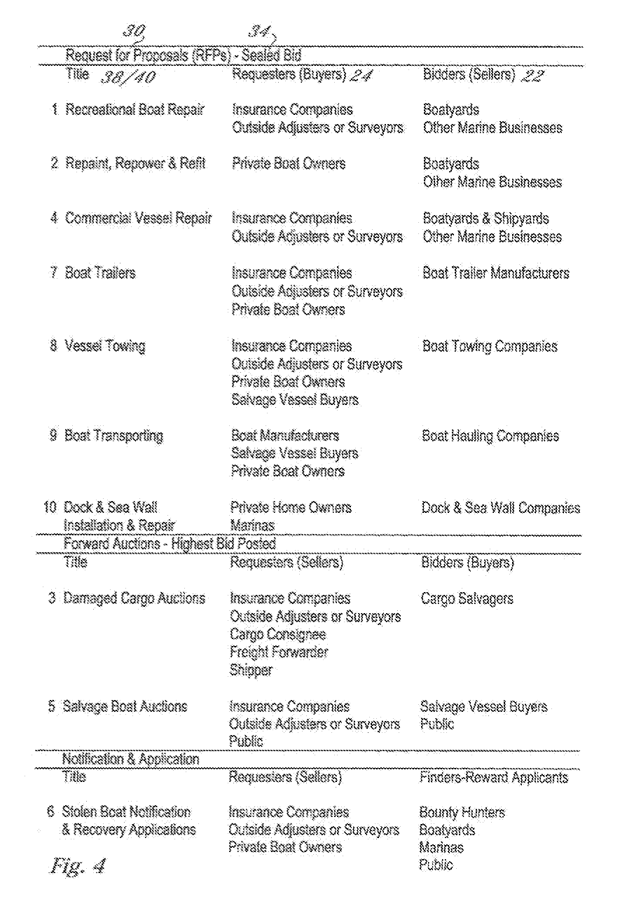

With reference to the flow diagram of FIG. 2, the basic inputs and outputs of the on-line procurement auction system are shown. More particularly, at the center thereof is RFP auction function 28 which, as is more fully set forth below, comprises a subset of the functions of server 20 referenced above. A partial listing of the RFP functions include: description (both written and visual) of vessel or cargo damage, insurance assessment, surveyor report, storage costs, repair costs, ship repairs legal liability insurance (“SRLLI”) costs, time to complete the job, sales tax, percent of total repair for expected supplement, salvage value, vessel and cargo transportation cost, and warranty work estimates. To the left of RFP auction function 28 is buyer/requester 24, that is, the party seeking a bid for a particular service. The buyer requester 24 will generate an RFP 30 which is transmitted by the network server 20 to seller/bidder 22. Therein, the prospective bidder may avail himself of the RFP function for network members who are subcontractors 32 that might offer goods or services needed by the prospective bidder to formulate a responsive bid 34 to in response to RFP 30. This bid will be processed by network server 20 in accordance with the program below set forth, and as one of its outputs will furnish to the buyer/requester 24 a list 36 of all qualified bidders that have responded to a particular RFP 30 with itemized bids. Examples thereof, namely RFPs and their participants are shown column format in FIG. 3 and web page format in FIG. 4. These, more particularly, indicate subject matter correlations between requesters 24 and bidders 22 with respect to particular goods/products 38 and/or services 40. Therein may be appreciated the range of parties that may comprise potential network buyer/requesters, on the one hand, and network sellers/bidders, on the other hand, as well as the range of goods and services to which the instant system, in its marine industry embodiment, is applicable.

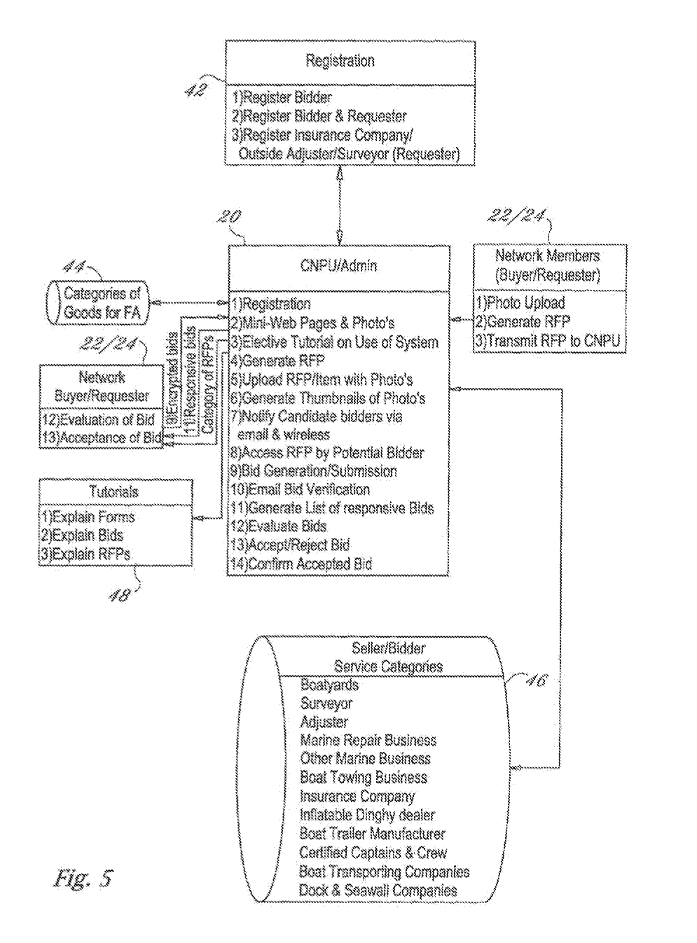

With reference to the state diagram of FIG. 5, there is shown, within network server 20, a list of the network server functions in the sequence in which they would typically occur during system operation. More particularly, this sequence of functions is as follows:

1. Registration by category of network member.

2. Automatically generated registrant profile into a mini-web page with photos.

3. Elective pop-up tutorials for use on an as needed basis

4. Generation of RFPs 30 with one or more items to be repaired, each having at least one photo per item.

5. Upload of RFP items and all photos.

6. During photo upload process, server 20 automatically generates thumbnail size photo on the display in the correct order for pop-up to larger photos.

7. E-mail and wireless distribution of RFP notices.

8. Bidder accesses RFP on-line.

9. Bid generation and submission.

10. E-mail bid verification back to the seller/bidder.

11. Generation of list of bids available to all participant bidders of an auction immediately after it has closed. The RFP buyer/requester is electronically notified of all itemized bids after payment of the service fees to a system administrator has been made.

12. Evaluation of list of bids by requester.

13. Acceptance or reject all bids of bid by requester.

14. Confirmation by server of acceptance of bid.

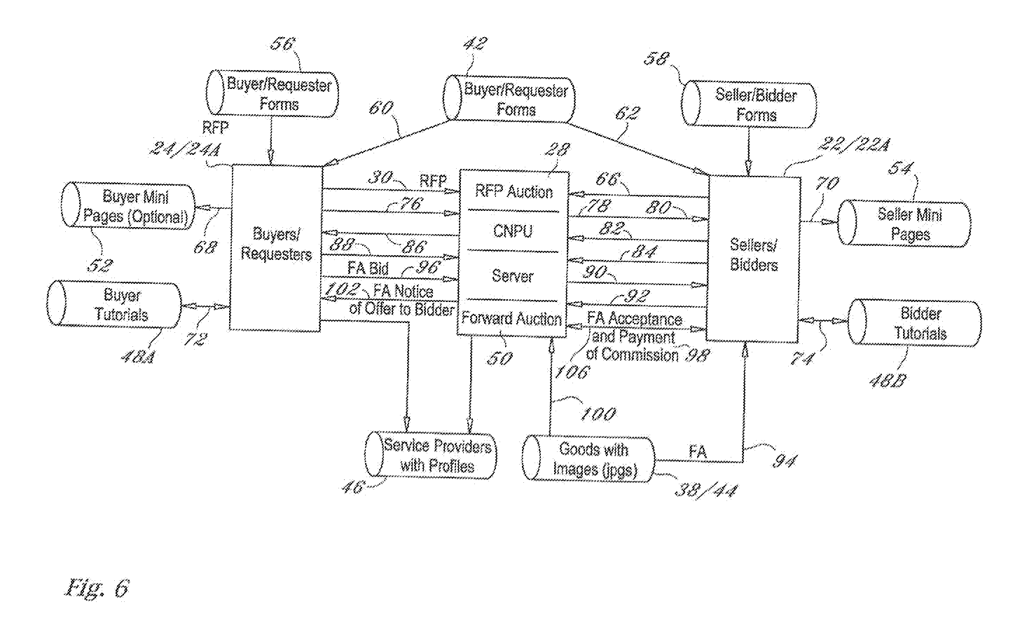

Some of the above functions are additionally shown within the network member blocks 22/24 shown to the left and right of network server 20 in FIG. 5. Block 42, which appears above server block 20, provides an indication of the range of different registration forms associated with the present system. This is more fully addressed with reference to FIGS. 6 and 19-20 below.

In FIG. 5, it noted that each functional database comprises a data partition of a single physical database. That is, database 44 contain categories of goods 38 such as boats or components thereof which are typically the subject of a forward auction, either generally as set forth below or, specifically, with reference to subcontractors 32 as above described with reference to FIG. 2. Database 46 is a database of seller/bidder service providers and bidder profiled mini-web pages with photos, that are network members who, on a particular occasion, may function as either a network buyer 24 or network seller 22. Elective pop-up tutorials 48 assist any network member in the use of registration forms, bid forms, RFP forms, and other aspects of the system, as are set forth below. An applicable elective pop-up tutorial is linked from substantially any page of the present program.

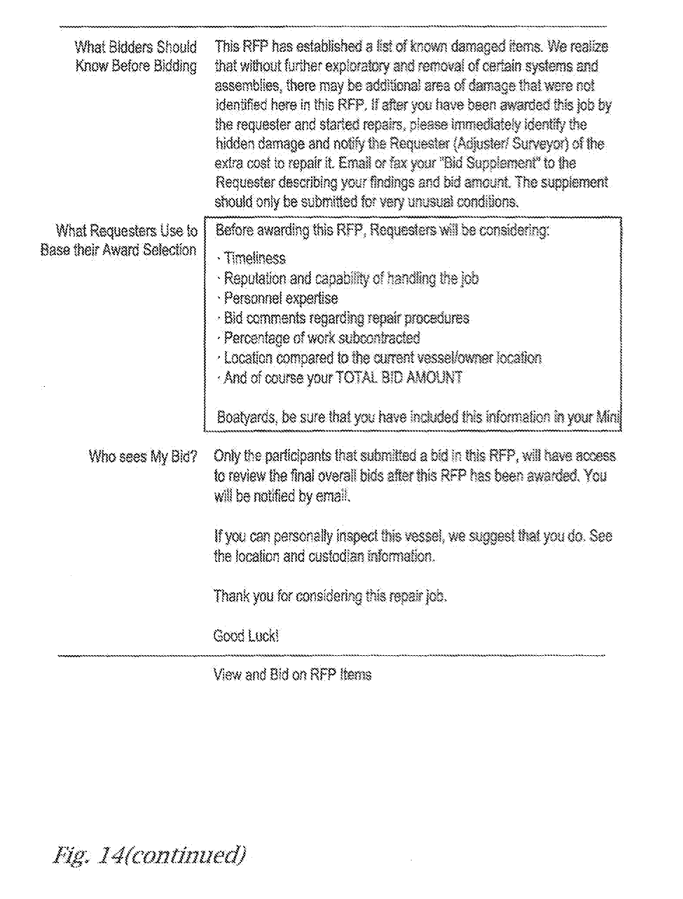

With reference to the network flow diagram of FIG. 6, there is shown the relationship between the server when employed both as a RFP auction 28 and a forward auction 50. Therein is included the buyer/requester 24, the seller/bidder 22, said database 44 of goods, said database 46 of service providers, optional buyer profile mini-pages 52 inclusive of jpegs, seller profile mini-pages 54 inclusive of jpegs, said registration forms 42, database 56 of RFP forms for buyers/requesters, database 58 of forms for sellers/bidders, database 48A of buyer elective pop-up tutorials and database 48B of bidder elective pop-up tutorials. FIG. 6 however is particularly notable in its illustration of information flow which enables each of the above set forth server functions of FIG. 5. More particularly, registration of buyers/requesters is shown through Lines 60 and 62 which indicate provision of appropriate registration forms 56 and the submission of the completed forms to the server 20, while Line 66 illustrates the completion of an appropriate registration form by a seller/bidder and the submission thereof to server 20. Line 57 indicates that the network buyer 24 may customize his form, as is more fully set forth in FIG. 15.

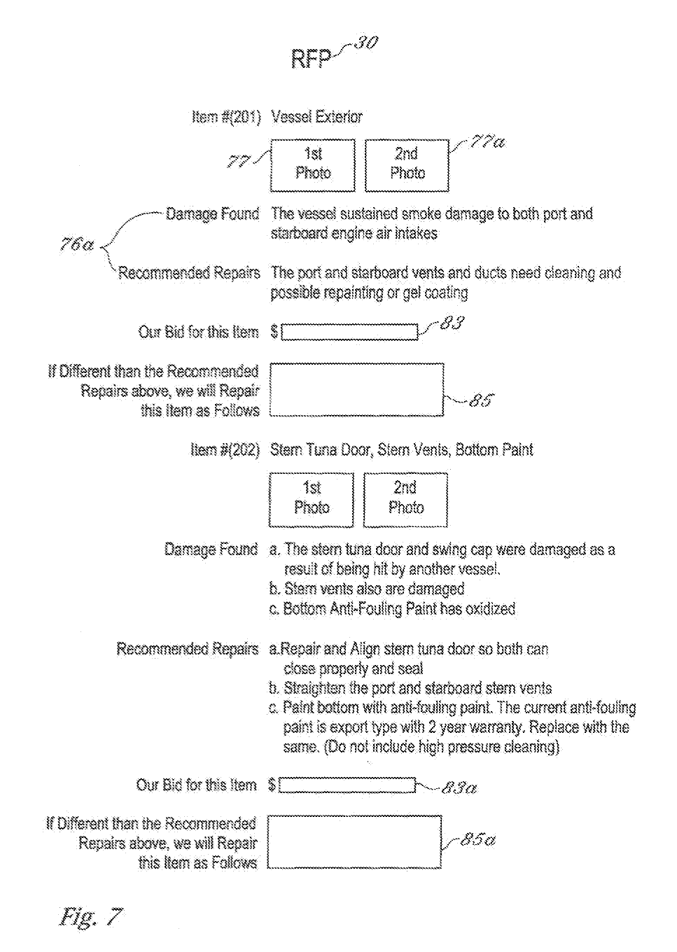

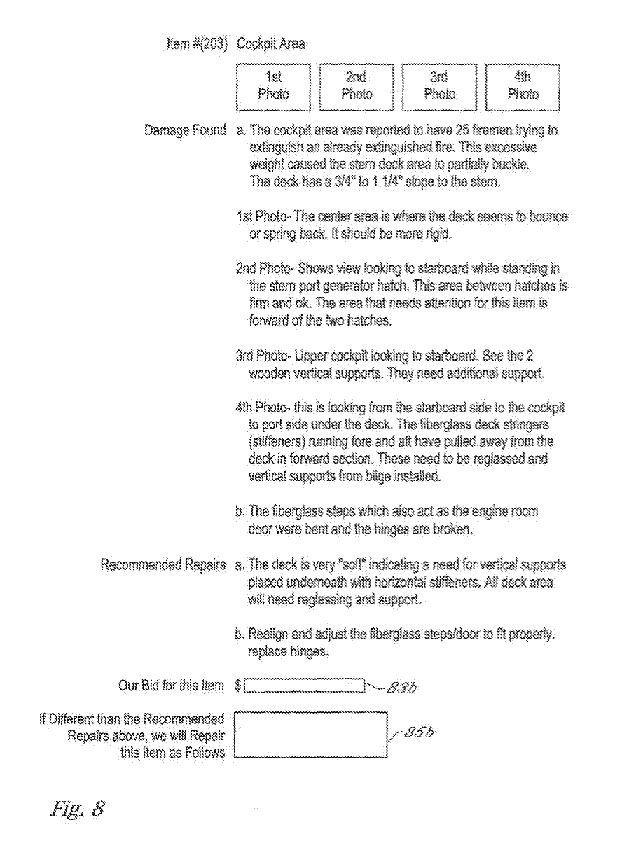

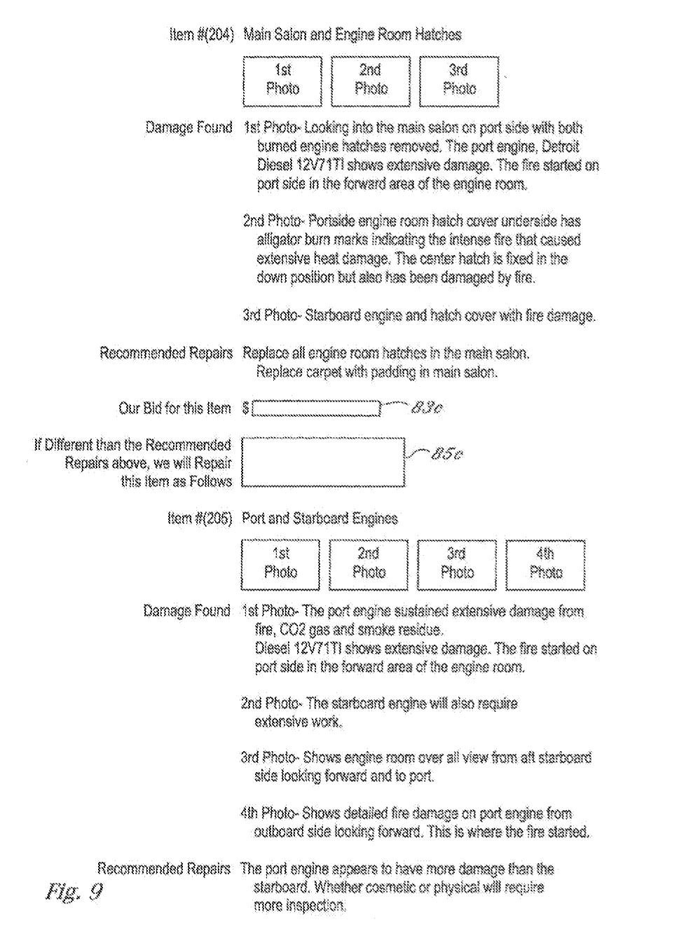

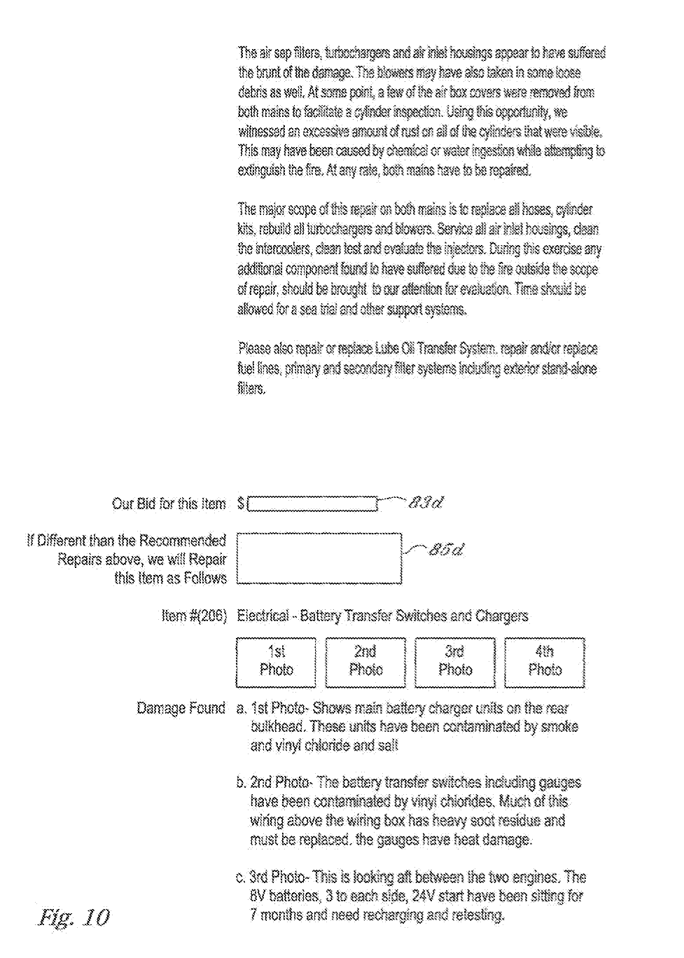

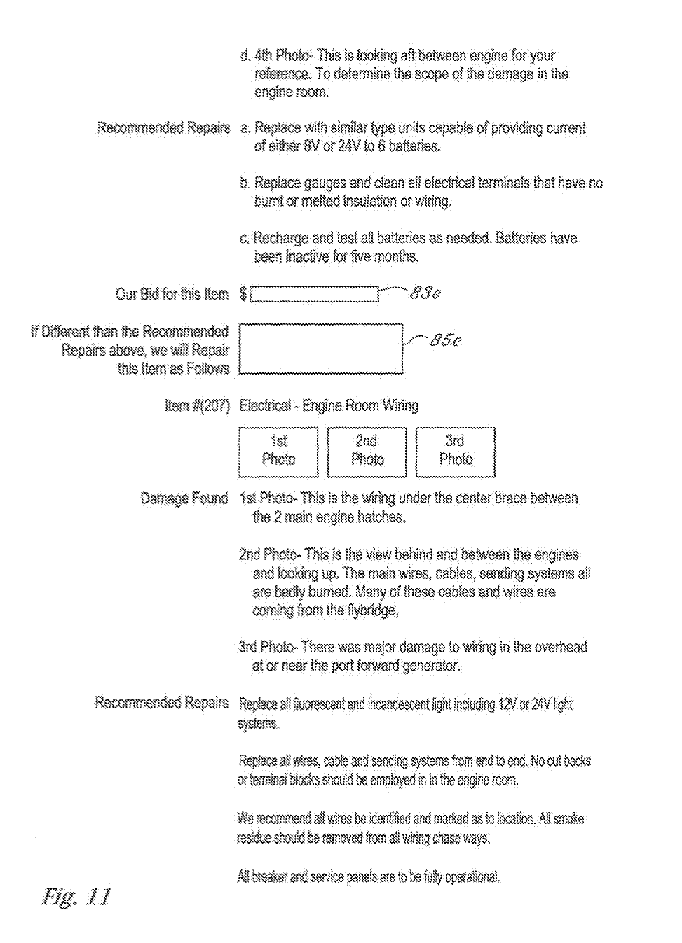

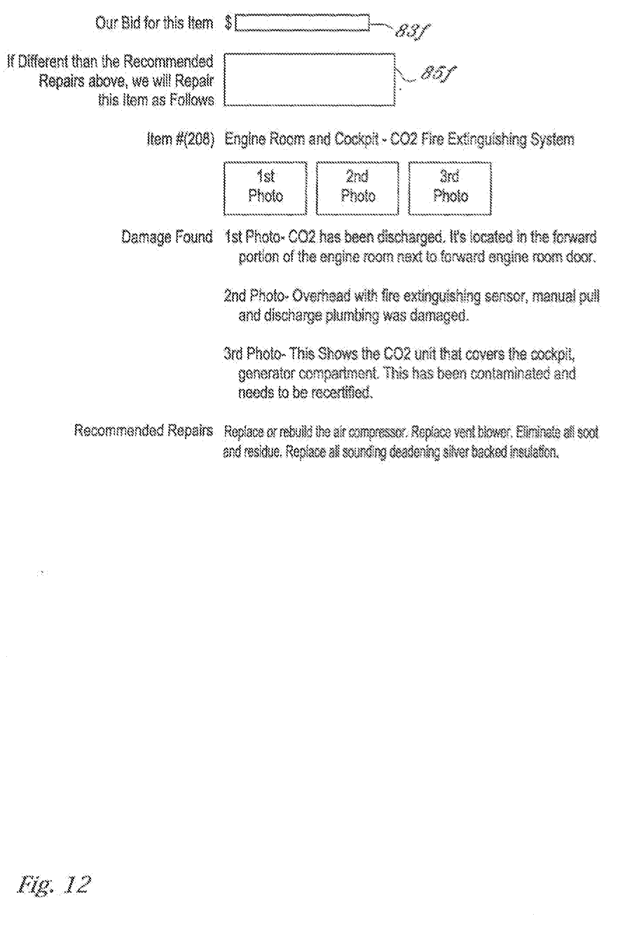

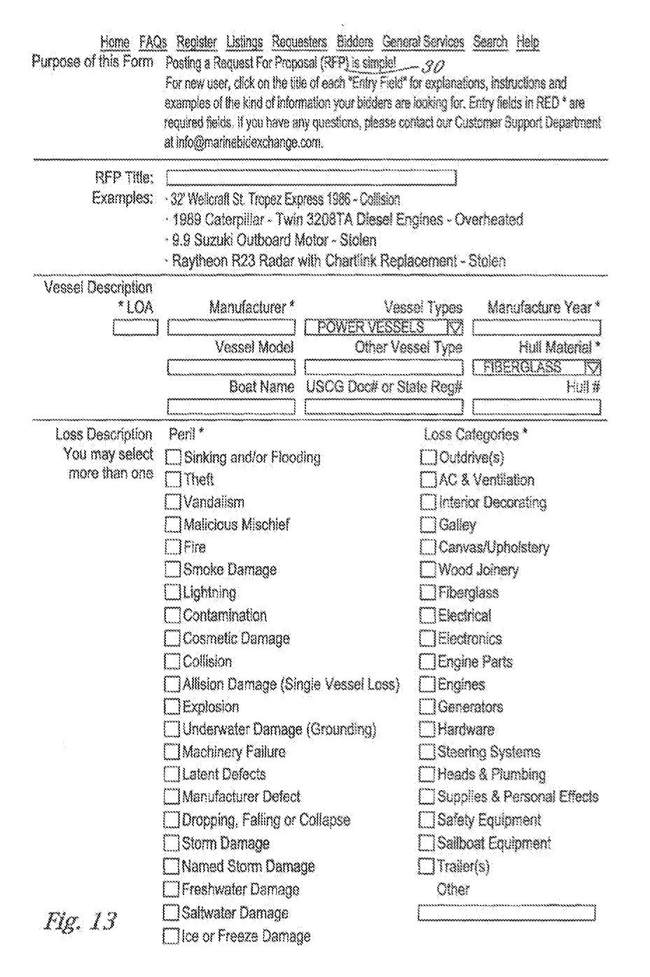

Following registration, a buyer/requester provides an RFP 30 including a narrative description of “damage found,” “recommended repairs,” and “photo uploads” 77/77a to describe the nature of the damage and recommended repairs, as is shown by Line 76 of FIG. 6. The buyer/requester 24 provides a description of “damages found” and “recommended repairs” 76a in the format shown in FIGS. 7 to 12, as is more fully described below.

An RFP 30 comprises at least one item but may include an unlimited number of items to be repaired. A buyer/requester 24 may upload at least one or a plurality of photos showing each item to be repaired. See Item Nos. 201 to 208 of FIGS. 7-12. Each photo will automatically, if clicked upon, zoom up to a much larger scale photo. This is done to allow more elective images per page while maintaining an acceptable downloading speed. This also allows the viewer of each page of thumbnail photos 77 to make one's own choice of which thumbnails to zoom-up, rather than forcing the viewer to view all large photos.

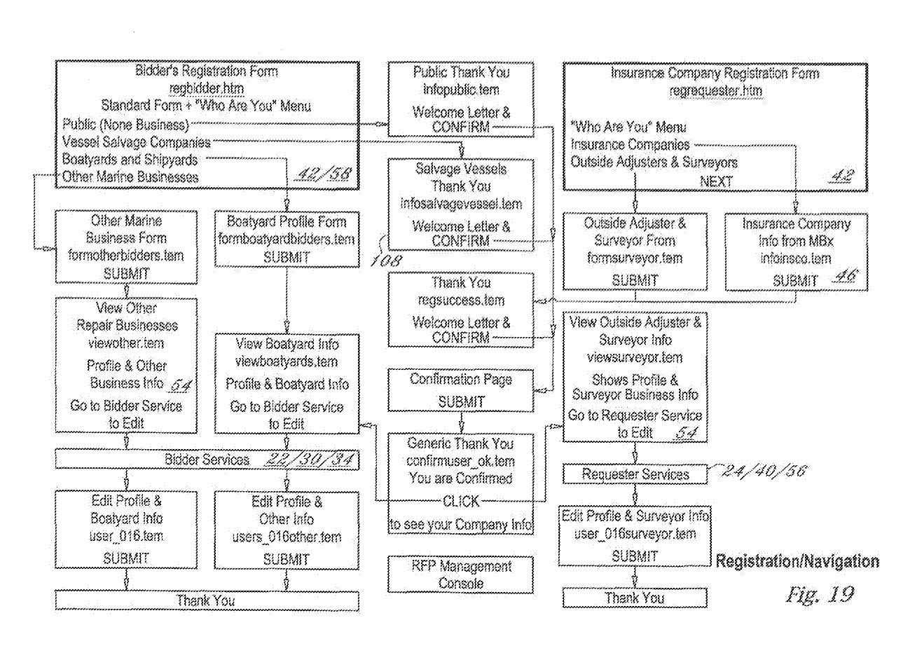

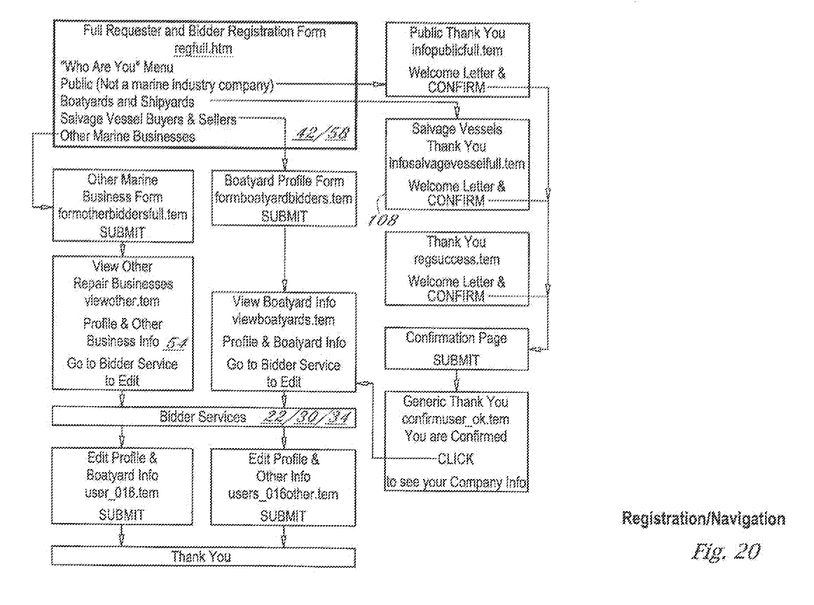

Users of this site, including both buyer/requesters and seller/bidders, may upload and size photos with their registration profiles or RFP items directly from their own computer. See FIGS. 19-20. The server will automatically re-size a photo and express it as a predetermined sized thumbnail photo without the need for user cropping, copying or resizing and renaming photos for the thumbnail. This also removes the burden of having to upload both the larger photo which would require more time and coordination by a user.

One benefit of the above is that network seller/bidder 22 may generate a mini-webpage inclusive of written and graphic information, as is indicated by 70 in FIG. 6. This profile becomes available to the requester to evaluate the bidder repair capability. The system can feature the system further including software for displaying all bids and a bidder's optional profile to the requester via the telecommunications network, at a time only after an RFP period has closed, so that a successful bidder may be selected. Although the system can perform an automated analysis of submitted bids to provide a recommendation as to the bid that should be selected by the requester based upon certain predetermined programmed criteria, by displaying all bids along with each bidder's optional profile, the requester is given the opportunity to select a bidder to perform the repair or salvage based on the requester's personal preferences that may not be accounted for in the predetermined criteria used to provide the system's automated analysis and recommendation.

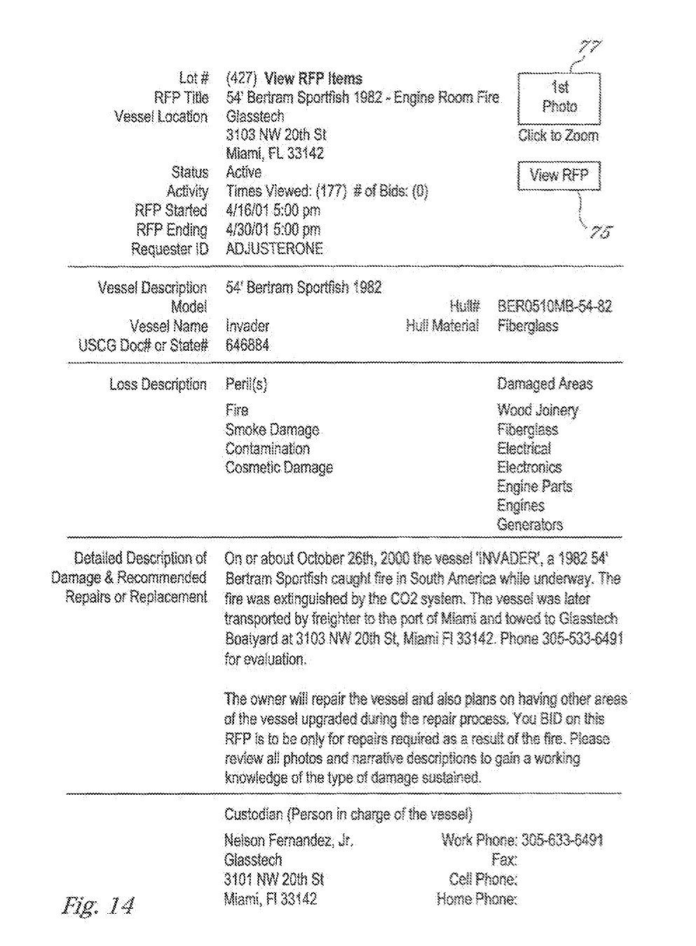

As above noted, elective pop-up tutorials 48 exist throughout the present system and, in FIG. 6 are particularly shown in databases 48A and 48B which are accessible to buyers and sellers as is indicated by Lines 72 and 74 respectively. The next step, when the system is employed in its RFP auction mode, is that of generation of the RFP 30. Therein, a requester 24 may employ forms from a database 56, of a type shown in FIG. 6 herewith. See also FIGS. 19-20. After this form is completed, the RFP 30 will appear on the system in the manner of the example of FIGS. 7-12. To access the detailed graphic and textual information of FIGS. 5-6, one may click on “view RFP” 75 of FIG. 14 or may simply click on any thumbnail photo 77 to see more of the subject of this RFP.

The generation and transmission of the proposal to the network server is shown as Line 76 in FIG. 6. Thereupon, the requester 24 may define a subset of network seller/bidders 22 suitable for receipt of the RFP in which a variety of criteria, both objective and subjective, may be employed. In an open bid scenario, the requester will then select the best candidate for the job. Therein, the requester may establish criteria, for given categories of services 46, on the basis of one or more of geography, capability, experience, peril classification, language spoken, and conditions of sale or offer. In many cases, a network seller/bidder will indicate an area of interest or non-interest, this in accordance with the form of FIG. 15 in which a network bidder is encouraged to complete, both as a matter of his own convenience and so that the system does not misuse resources in sending RFP notices of a type that a particular bidder would have no interest in.

In addition, a buyer/requester 24 is permitted to construct a “private auction” wherein the requester must approve all prospective sellers/bidders 22 in which he wishes to participate. Also, the buyer/requester may elect at the time of RFP setup to password protect the auction. Such auctions will, it is believed, become quite common inasmuch as, in certain niche industries, such as the marine industry, a buyer/requester will typically have a good sense of the qualified sellers/bidders to which he would entrust his work. Accordingly, it would not be unusual for a private boat owner or a boat manufacturer, having warranty or service requirements, to specify a short list of network seller bidders for consideration of his RFP. As such, the present system can readily be adapted to either impose such a short list for a private RFP auction or, as above set forth, apply general constraints relative to geography, peril classification or the like; or said criteria may be bypassed entirely.

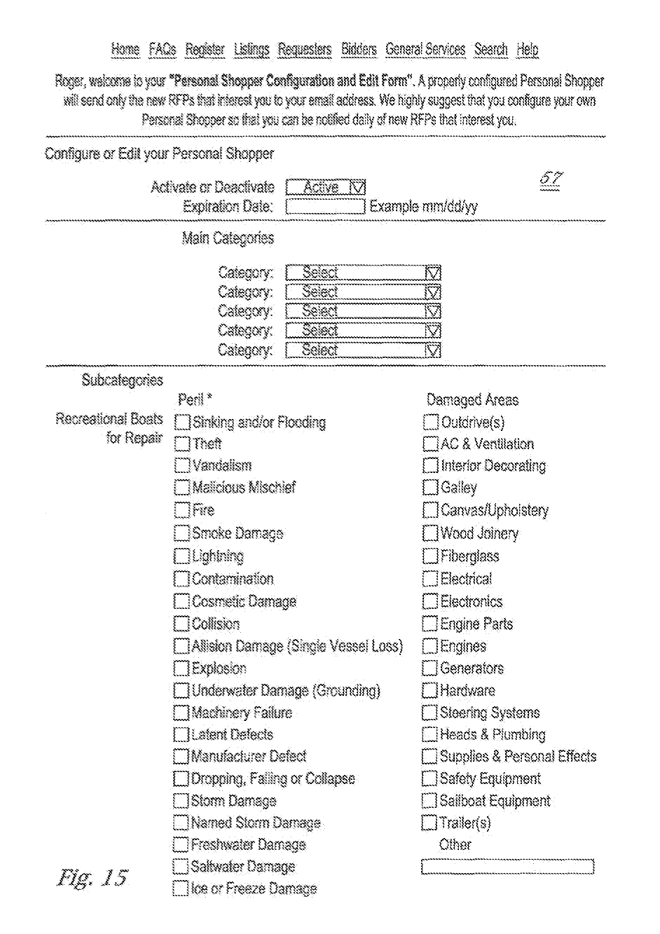

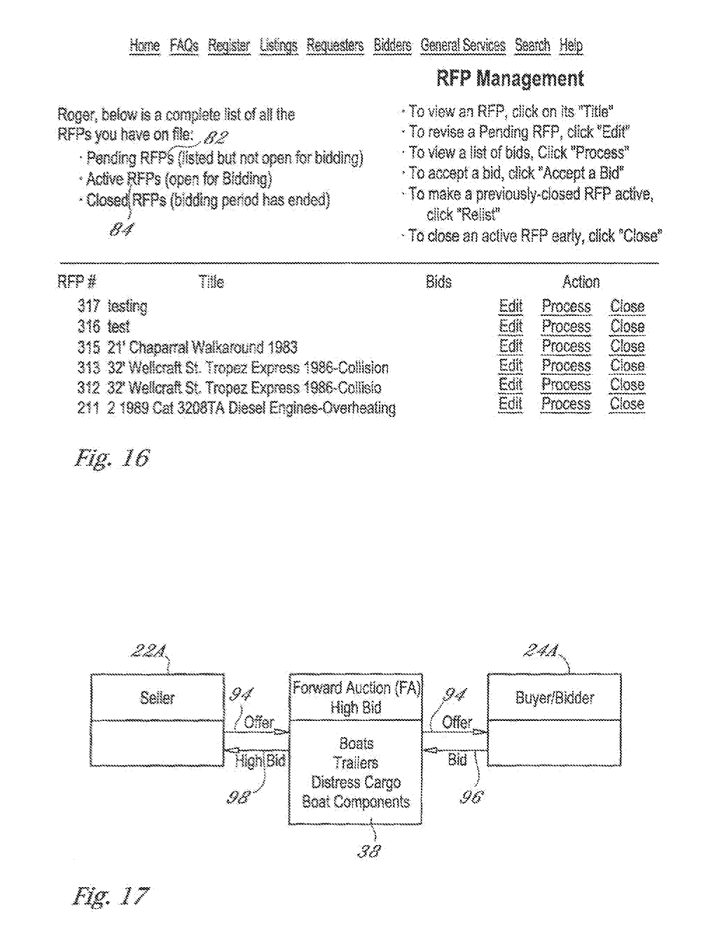

After an appropriate subset of candidates of seller/bidders has been determined, the RFP notices are transmitted to the selected group of network sellers/bidders by both e-mail and wireless means as in indicated by Line 78, and by a line segment 80 thereof which indicates receipt of the RFP notice by both e-mail and wireless means. Thereupon, seller/bidder 22, employing bidder elective pop-up tutorials 48B, as needed, and attaching his seller mini-pages 54, as needed, will generate a bid which is forwarded to server 20, as is indicated by Line 82 of FIG. 6. During the bidding process, the seller/bidder 22 views (typically five) items per page by electing to expand the thumbnail photos for a closer look at the actual damage as well as to evaluate the buyer/requester's “damage found” and recommended repairs.” The seller/bidder then enters his respective bid amount 83-83f and a narrative 85-85f on how the repairs would be done if different than the buyer/requester's recommended repairs. See FIGS. 7-12, and FIGS. 19-20. The bidder then submits all items and moves on to the next page of item to evaluate and possibly bid on. After the bidder has placed bids on all items in the RFP 30, he may go back and change his bid or conditions of the bid on any item, using the final bid sheet. Once the bidder is happy with all his bids, the bidder selects “confirm bids” 84 so that his bids on all items become “active bids” and cannot be changed. See FIGS. 6 and 16. That is, the bidder must eventually bid on all items comprising an RFP 30 to produce a finalized bid that will be processed.

After the RFP period has ended, the buyer/requester is automatically invoiced for auction service fees. After the system administrator is paid, an e-mail notice is sent to the buyer/requester to process all bids, as is indicated by Line 86. In selecting the winning bidder, the requester 24 may apply his own personal and subjective consideration to all bids, not only the lowest bid as is typical in the prior art of RFP auction systems. Therein, although the fee paid by the buyer/requester is a function of the lowest good faith bid, the requester is under no obligation to accept the lowest bid. In other words, a requester can select a criterion such as, for example, geography, capability, experience, peril classification, language spoken, and conditions of sale or offer that the requester finds satisfactory if the requester does not elect to “reject all bids.” If so, e-mail notices 86 are sent to all selected bidders that all bids of that RFP were rejected. The buyer/requester is however still charged a transaction fee but is given credit towards his next RFP. Line 88 of FIG. 6 indicates the acceptance of a bid by the requester and the transmission of such acceptance to server 20 whereupon the successful bidder is notified as is indicated by Line 90. The selected bidder is then asked to confirm his acceptance of the bid, which is indicated by Line 92.

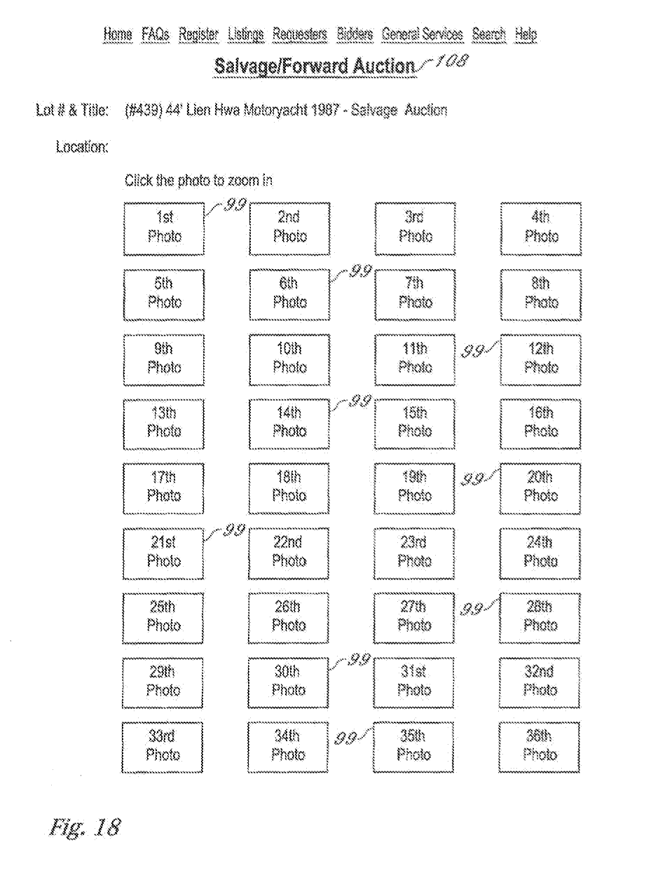

The forward auction 50 of the present system is much simpler in concept than is the above described RFP auction and is shown conceptually in FIG. 17 and, more particularly, in said FIG. 6 with reference to those lines using the nomenclature FA. As be noted in FIG. 17, the forward auction 50 is simply a matter of the forward seller 22A listing a particular cargo or product 38 or vessel and the transmission of such an offer 94 to forward buyer 24A who, if interested in product 38, will generate a bid 96 whereupon the forward auction 50 will simply transmit high bid 98 to the forward seller 22A. Forward auction subjects may be selectably viewed by clicking upon any of thumbnail photos 99 of FIG. 18. In the present system, a seller may also view the bid history of a subject should he wish to do so. The above is shown in further detail in the system flow diagram of FIG. 17 in which offer 94 may be seen emanating from a seller in which data database 38/44 may be used to attach an appropriate jpeg to the offer if the seller has not already done so. Thereupon, the offer of sale will be transmitted as indicated by Line 100 to the forward auction 50 of the server 28. Notice of the seller's offer is then furnished to a prospective buyer as is indicated by Line 102. An FA bid 96 then be forthcoming from an FA bidder as is indicated by Line 96. In a “sealed bid” auction, the high bid 98 is communicated to the seller 22A who, if he wishes to accept the high bid, will indicate his acceptance thereof as is indicated by Line 106, whereupon confirmations are sent out to both parties by the server and the commission is paid by the seller while the purchase price is paid by the buyer 24A to the forward auction 50. In an open bid auction, the highest bid is the winning bid, which is determined by the server 28 immediately at the end of the auction

It is noted that a forward auction 50 and, particularly, a salvage auction 108 (see FIGS. 18-20 and 23) of a vessel cargo or any other commodity may function concurrently with an RFP auction 28 of the same vessel cargo or any other commodity as above set forth, this to effectively determine if a vessel is a total loss or if it can be cost-effectively repaired.

In a damage or salvage cargo auction, FA bid 96 comprises two parts, namely:

(a) Bid to purchase as is; and

(b) Bid to repair (not purchase) for continued shipment to final destination. This corresponds to the function of Line 76 of a proposal in response to an RFP. See FIG. 6.

A screen page of the program showing the manner in which the system user can readily insert himself into different steps or aspects of the inventive system is shown in FIGS. 14-16 which indicates the manner in which a network member may observe pending, active and closed RFPs and, as well, may, within time sensitive parameters, effect a revision of a pending RFP or a re-listing of an existing RFP. The right side of FIG. 16 is therefore a management page of the system,

In FIGS. 19 and 20 are shown, in greater detail, the functions associated with the use of registration form database 42, requester registration forms 56 and bidder registration forms 58. Therein the adaptation of the present system to the particular needs of different network members, e.g., vessel salvage companies, boatyard and shipyards, insurance companies, outside adjusters and surveyors, salvage vessels, brokers, and interested members of the public are accommodated.

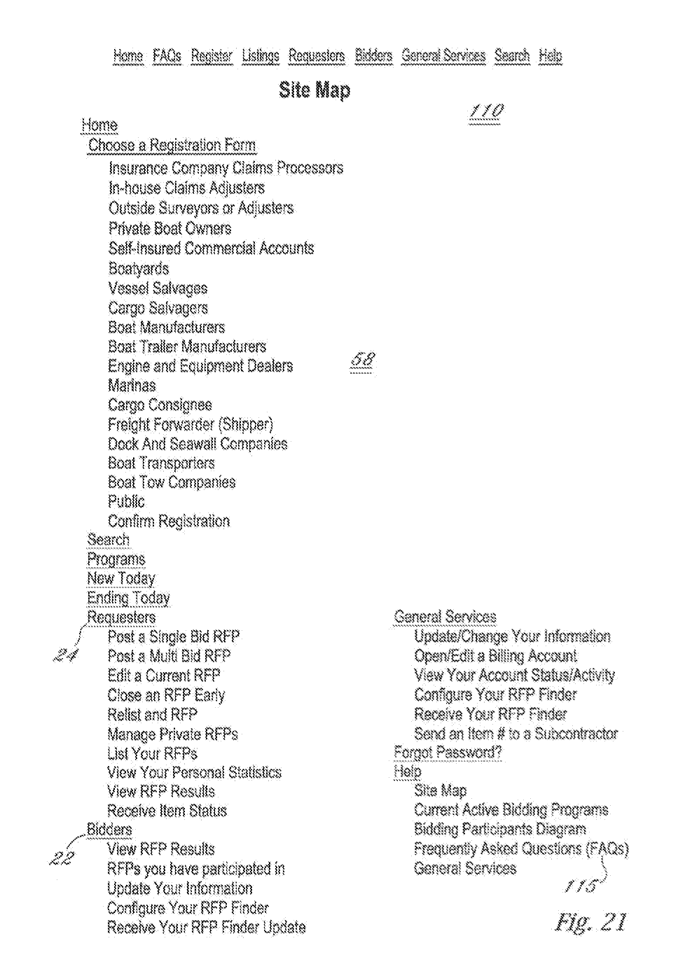

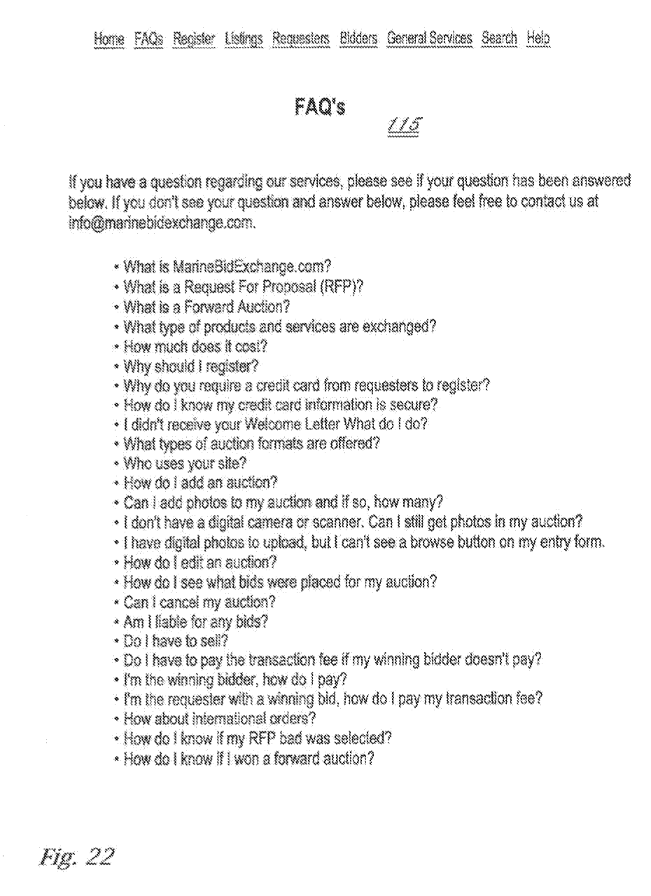

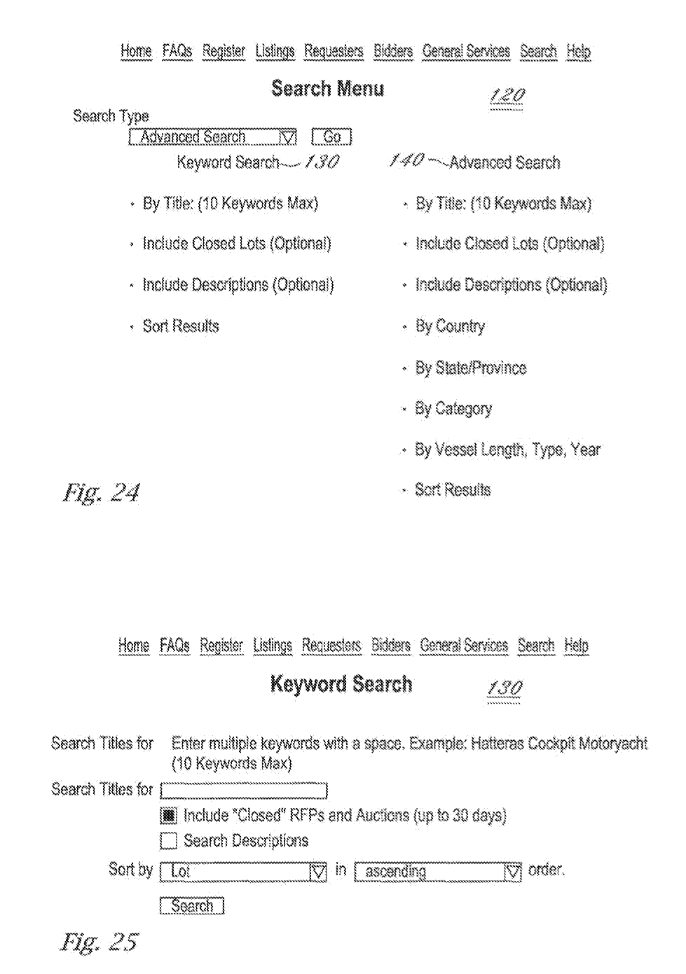

Shown in FIG. 21 is a screen page of a site map 110 of the present procurement auction system showing thereof the direct linkage from the site map to an applicable registration form, and other forms, such as forms 58 employed by bidders 22. Also linked to site map 110 is a search program 120 and frequently asked questions (FAQs) 115 which are further shown in FIGS. 24 and 22 respectively.

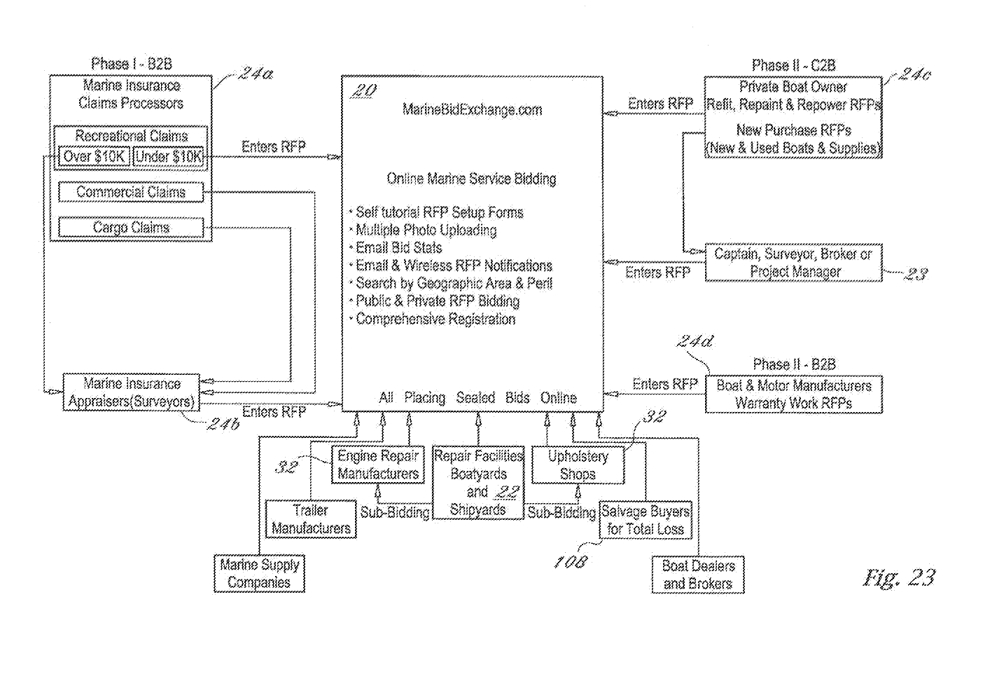

In FIG. 23 is shown a summary of the various benefits and applications of the system, this inclusive of the above-described sub-bidding functions 32 available to network sellers/bidders 22. Thereby, through FIG. 23 there may be appreciated the range of both B2B (business-to-business) and C2B (consumer-to-business) applications of the system, this both at various points in the chain of channel of distribution of marine related goods and services. Compare, for example, Phase I-B2B and Phase II-B2B.

With respect to marine insurers 24a, in Phase I of B2B, the system is beneficial for: lowering loss ratios because of lower claim processing expenses; avoidance of “captured” vessels; ensuring more competitive and lower bids; providing faster, easier and more credible bids; allowing concurrent repair and salvage bidding; providing open and easier claim supervision; and reducing the amount of litigation related to claims concerning damaged property and its repair or salvage.

With respect to marine surveyors 24b in Phase I of B2B, the system is beneficial for: providing self-tutorial RFP input forms; for inside adjusters, ensuring smaller losses that are easier and faster to process; allowing easy digital photo uploading; providing printed photo scanning service; obtaining unbiased bid data; providing links to the marine surveyors' own websites; ensuring increased visibility and creditability for the marine surveyors, and thus, more jobs; and ensuring availability at all times via a business presence on the Internet.

With respect to private boat owners 24c in Phase II of C2B, the system is beneficial for: lowering repair and maintenance costs; obtaining more competitive and lower bids; ensuring the avoidance of “captured” vessels; and ensuring faster, easier and more credible service to the private boat owners.

With respect to manufacturers 24d in Phase II of B2B, and their warranty work, the system is beneficial for lowering the cost of repairs, reducing the amount of time needed for repairs, providing self-tutorial RFP input forms, allowing easy digital photo uploading, providing a printed photo scanning service, providing links to on-line manuals, providing links to the manufacturers' own websites, and ensuring availability at all times via a business presence on the Internet. Using the system allows manufacturers to avoid sending key employees with knowledge of the product to conduct warranty repair claims work.

With respect to captains, brokers and project managers 23, Phase II C2B benefits can include: self-tutorial RFP input forms; easy digital photo uploading; printed photo scanning service; links to their own website; and availability at all times via a business presence on the Internet.

With respect to all categories shown at the center bottom of FIG. 23, the system can be beneficial in lowering the cost of finding work at any time, providing more damage data and therefore better bid accuracy, ensuring a more stable employee workload, and reducing litigation or conflict regarding costs.

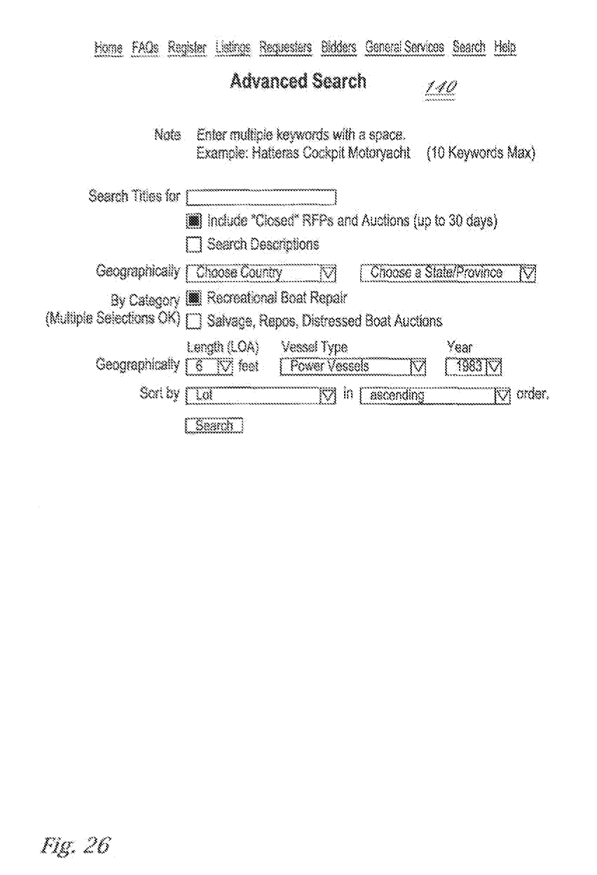

FIGS. 24 to 26 illustrate a system search menu 120 which is linked to a keyword search 130 and advanced search 140 respectively.

The system provides a dual auction process in which an auction for sale of a damaged vessel can be conducted simultaneously with an auction for repairs thereby providing an automated direct cost/benefit comparison of the cost of repair versus the benefit of sale. An insurer or property owner can use the system's automated analysis results and recommendation to make a determination as to whether damaged property should be repaired or sold for salvage depending on the cost of repair versus the financial benefit of sale of the damaged property.

Additional Features

The system includes the network server, which is communicatively connected to a telecommunications network (e.g., the Internet, a VPN, WAN, or a LAN). The telecommunications network can be wired or wireless. The software of the system and its modules can be installed on the server. Databases of information submitted to the system by customers creating requests for proposal and by bidders can also be stored on the server or on another server or memory storage device that is communicatively connected to the server. The system can be accessed on the server via a website that can be accessed by the user (i.e., the customer or bidder) using a computer that is communicatively connected to the telecommunications network. The system can allow a plurality of computers to access and use the software installed on the server via the website. The computer that accesses and uses the system can be any type of computing device having a connection to the telecommunications network, for example, a desktop computer, a laptop computer, or a portable computing device such as a tablet computer, personal digital assistant (PDA), or smart phone. In another embodiment, users visiting the website for a first time may be prompted to download software that can be installed locally on the user's computer through which the system is accessed after a registration process. Users of the system can include requesters, i.e., customers creating RFPs, and bidders. Bidders can include repair bidders and salvage bidders. Both RFPs and bids are created within and submitted through the system using its software accessible on computers connected to the server via the telecommunications network.

The system can include a bidder profiling system module by which, before repair bidders are permitted to participate in the procurement auction, they are asked a plurality of questions relevant to the industry related to the damaged property. For example, the plurality of questions asked to the repair bidders can be related to licensing, liability insurance, bonding, years of experience, technical staff qualifications, or requests for photos of their repair yards. The bidder profiling system module can be programmed to automatically disqualify potential bidders who do not meet requirements or specifications of the customer or the relevant industry. The bidder profiling system module can track information related to repair bidders' past history of bids and repair jobs. The system module can be programmed to alert a bidder concerning jobs with criteria the bidder has satisfied in the past. For example, a bidder may be alerted to information related to tornado repairs needed to a home in the same zip code where the bidder is already repairing another home. In this way, the bidder profiling system module allows for economies-of-scale during natural disasters or other events causing widespread property damage. The bidder can use equipment and supplies already located nearby at another job rather than relocating equipment and supplies from a more remote location. This feature can reduce the costs related to repair for the insurer or property owner and may also increase the repair bidder's profit from a job. In one embodiment, the bidder profiling system module can also incorporate customer reviews and ratings and bidder responses to those reviews.

To expedite disaster relief, in some embodiments of the system, insurance personnel may upload bidding parameters for residential or commercial property repair via a satellite connection to a communications network, thereby permitting bidding within hours of property damage.

The system can also include features for expediting and streamlining the building inspection process. Proposed building and repair methods can be made available online via the system for review and approval by municipal building inspectors. The system can also include features that permit users to add comments, for example, comments concerning job or experience requirements, which are made immediately available to architects, contractors, and other vendors.

The system can also feature a bidder feedback compilation module, which compiles bidders' technical revisions into a side-by-side comparison viewable on the display screen of a user's computer and printable by a printing device. The side-by-side comparison permits improvements to building methods, materials, and the scope of the work, and selection of innovative and otherwise superior contractors.

The system can include a bid-conflict identification and resolution software component that invites bidders to make technical revisions to itemized job descriptions posted by a customer. Technical revisions can create conflicts between the request for proposal and the bid. The bid-conflict identification and resolution software component automatically identifies the conflict and corrects for it, thereby allowing for a dollar-for-dollar comparison. The system incorporates revisions made by individual bidders, collates them, and automatically assigns a financial value, so that once again, the bids are subject to comparison with other similar jobs.

The system can also include a cost overrun identification software module that anticipates repair and building cost overruns, requires such cost overruns to be estimated or capped by contractors, and distinguishes cost overruns from other costs. The cost overrun identification software module segregates, but flags, cost overruns so that the bottom-line bid is not affected; the basic bids are still compared to bids for similar jobs.

The system can feature a plurality of templates designed for usage by specific industries and sub-industries, which may be completed by customers submitting information requested in the template and used to request bids for jobs and particularly for jobs with very industry-specific circumstances (e.g., bidding construction of new wharves, dredging a harbor, laying an undersea cable). Customers can request bids for these particular jobs while not being obligated to use any particular aspect of the industry-specific software information submission templates. This permits a proven and reliable process to be applied to very particularized circumstances. This feature also permits requests for proposal to be customized to meet the requirements of each specific insurance policy issued by or to users of the system. This feature allows differences in rates of depreciation of repaired items of property based on age, use, condition, or other criteria specified in the insurance policy covering the specific item of property.

The system permits warranty information providers by bidders to be segregated from bid data so that the comparison of bids (e.g., the cost of repairing) is not affected or distorted by variations among the warranties provided by different bidders.

The system can include a software module and methods that permit repairs not covered by insurance to be segregated for bidding purposes from those repairs that are covered by insurance. This non-covered repair segregation feature allows for acceptance of bids for repairs that the insurance carrier will not cover under a subject insurance policy without distorting the comparison of costs of covered repairs.

As requests for proposal and bids are submitted for various projects, the system compiles this data and generates statistics stored in databases, which can be accessed via the telecommunications network and used in the marine-insurance industry to provide actuaries with cost analysis for specific risks associated with specific types of vessels (e.g., trawlers, sailboats, or yachts) and specific geographic regions. These statistics can provide scientific parameters to determine and set insurance premiums.

A confidentiality option may be included as a control feature of the system. The confidentiality option may be activated (e.g., in a settings menu of the system software) to restrict viewing of the request for proposal to only those contractors (i.e., bidders) who are qualified to perform the work. Qualification of bidders can be determined by the system automatically by electronically referencing each bidder's profile, which each bidder creates during registration with the system, to review, for example, the bidder's licensing, experience, and field of expertise.

The system can also fragment job bidding to assist in eliminating reluctance by some contractors to bid a total price for the entire repair project rather than a price that excludes costs related to work by subcontractors. The job fragmentation option of the system requires, and facilitates, the bidder's consultation with subcontractors in the course of preparing an online bid.

By requiring the input of predetermined fields of information related to a repair job by a bidder, the system can ensure that overlapping and critical aspects of the repair work are considered by each repair bidder. In this way, the system encourages the early participation of project managers by bidders and potentially lowers costs and increases time savings by recommending bid awards in an automated process to construction bidders who possess certain competitive advantages such as, for example, having trained craftsmen and state-of-the-art equipment.

The system can also feature a pre-insurance screening process module and methods. The pre-insurance screening module automates analysis of deficiencies in property before it is insured. The results of the pre-insurance analysis can then be used by an insurer to make an informed decision either to provide or deny insurance coverage, or alternatively, to conduct a repair auction that can be used to make uninsurable property otherwise insurable. Insurers gain business that is less vulnerable to risks, and property owners have lower premiums and compliance expenses.

The system can also include an express auction process and methods, which can be implemented quickly (for example, within a period of about one to about twelve hours) from posting the request for proposal in the system to receiving a final bid for recovery of a stranded vessel or a sunken vessel. The express auction sets a shortened time period for bid submissions while providing assurance that bidders will be paid. The express auction process also anticipates additional costs after a sunken vessel is raised, such as, for example, towing to safe harbor; costs to flush, rinse clean and preserve engines; and daily storage rates.

In one alternate embodiment, the system can feature a pre-spill oil spill cleanup bidding module. The request for proposal for cleanup bids can be solicited from bidders after an oil spill occurs to select a bidder with the ability to clean the contaminated area. The request for proposal for cleanup bids can also be solicited from bidders before a spill actually occurs to identify contractors having the ability to respond immediately in the case of an oil spill, and to determine what the precise terms of each bidder's contract will be in the event of such a spill. Bidding for oil spill cleanup can be by solicited for regions or for specific geographical locations.

In other embodiments, the system can also include bidding methods and processes that solicit bids from contractors for repairing damaged cargo. The system can facilitate bidding by contractors that specialize in repairing (or “making sound”) damaged cargo from trains, ships, trucks, and airplanes. The system can include a parallel bidding process that allows the same cargo to be sold to the highest bidder, after repairs.

In other embodiments, the system can also include bidding methods and processes that solicit reward offers for stolen property. The stolen property reward process allows customers using the system (both public and private, including law enforcement) to post details related to stolen property, e.g., a stolen yacht or other high-value stolen property, and a reward for the property if returned or located. Once the stolen property is located, the person, group of people, or entity locating the property can submit contact information and the property's location through the system. The person, group, or entity to first accurately identify the location of the property through the system is entitled to the reward, thereby avoiding the common controversy that arises between individuals, groups, or entities with competing claims concerning who located stolen property first so as to be entitled to the reward.

In other embodiments, the system can also include bidding methods and processes that solicit bids from contractors for scrap wrecking auctions thereby permitting bidding for old and damaged vessels that are to be disposed of and disassembled for scrap metal, parts, and equipment.

In other embodiments, the system can also include bidding methods and processes that solicit bids from contractors for ocean, reef, sea grass, or seabed restoration to restore a natural area after environmental damage has occurred (e.g., damage caused by ship grounding).

In other embodiments, the system can also feature bidding methods and processes that use automated features of the software to solicit bids for the cleanup and removal of hazardous and toxic material either from spill sites or from contaminated vessels. For example, bids may be solicited to clean up and remove hazardous chemicals from a vessel that is to be used to construct an artificial reef.

The system can also include a timing software module that adds a predetermined period of additional time (e.g., 10 minutes) to extend the length of an auction whenever one or more bidders submits a new bid within a certain predetermined period (again, for example, 10 minutes) prior to the expiration of a running auction. The system can be automatically programmed to continue extending the length of the auction by such an extension period as long as bidders continue submitting bids within the predetermined period preceding the regularly scheduled expiration of the auction. Such timing software of the system prevents last minute bidding by bidders who attempt to submit a bid only a nominal amount (e.g., $1.00) lower (in the case of repair bids) or higher (in the case of salvage bids) than the last submitted bid in an attempt to win the automated auction.

The system can also include software programmed to pre-assign the starting amount of the next highest (in the case of salvage bids) or lowest (in the case of repair bids) bid that must be submitted to constitute a valid bid that will be accepted by the system. For example, if a forward auction for salvage is being conducted and the last bid is $125,000, in order to outbid the previous bidder, another bidder would be required by the system to bid at least $125,250 to win the auction. In this way, the system and its pre-assigned bid amount software module can prevent bidding in very small sums that unnecessarily prolong auctions.

The system can further include a proxy bidding software module whereby a salvage bidder who wishes to participate in a forward salvage auction can pre-set the bidder's maximum bid to an amount determined by the bidder as well as a maximum bid increase increment by which the bidder's initial bid will be increased to counter and beat any competing bid that is submitted by another bidder. For example, when an auction begins, once the software installed on the server receives a first bid (e.g., $20,000) from a first bidder, a second bidder's account on the server, which has been programmed using the proxy bidding software module, will then submit a second bid on behalf of the second bidder to outbid the first bid of the first bidder by the maximum bid increase increment pre-established by the second bidder in the second bidder's account settings. In this example where the first bid by the first bidder is $20,000, the second bidder's maximum bid increase increment might be $200.00, in which case the second bidder's system account automatically submits a second bid in the amount of $20,200 to outbid the first bidder's first bid. In this way, the system can act as a proxy bidder for the second bidder even if the second bidder is not personally able to be present online to monitor and bid in the auction. The second bidder's proxy bidder account settings in the system to continue outbidding other bidders in maximum increments of $200 until the second bidder's maximum bid amount is reached (e.g., $50,000). When the second bidder's maximum bid amount is reached, the second bidder will either have won the auction if the second bidder has submitted the current highest bid and the auction has ended, or the second bidder will have been outbid and no new bids will have been submitted on its behalf once the maximum bid amount limit is reached. The proxy bidding software module is particularly useful to avoid losses by bidders in auctions in the event of power failures, disruptions in service of the telecommunications network provider, or other unexpected technical problems. As the total current bidding amount increases, the proxy bidding software can also be programmed to increase the amount of each maximum bid increase increment that is submitted in response to new bids placed by other bidders. For example, if the current bid was approximately $200,000, the maximum bid increase increment could be $150, whereas if the current bid increases to or exceeds $400,000, the proxy bidding software could be programmed to increase each maximum bid increase increment to, for example, $375. In any given auction, both proxy bidders, which are part of the system, and live bidders may be participating in bidding for the damaged property.

A reserve price may also be established by the requester, which is the minimum price at which the requester will agree to sell the property in a salvage auction. In an exemplary embodiment, the reserve price is hidden in that it is not displayed or otherwise reported to bidders by the system. The system can be programmed to permit bidding to begin at amounts that are lower than the reserve price, which is one technique for generating interest in a property that is being auctioned; however, if the maximum bid amount is lower than the reserve price, the system can generate a notice that is displayed to the bidder submitting the maximum bid, to a predetermine number or percentage of bidders with the highest bids, or to all bidders, that the maximum bid does not meet the requester's reserve price and that the auction will continue until the reserve price is met or the property will not be sold.

In an exemplary embodiment, as new bids are submitted, the system can be programmed to automatically display new bids to each bidder. New bids may be automatically displayed in real time as they are submitted or at generally short predetermined intervals (e.g., 3 seconds, 5 seconds, 10 seconds, 30 seconds, or 60 seconds), the system may automatically refresh the webpage to display new bids. In other embodiments, the bidder may be required to click on and use a refresh page feature, either of the system or of a web browser software application through which the system is being accessed, in order to reload the webpage to show updates to the bids that have been submitted.

In one embodiment, the system might also be used by a repair bidder to bid to repair a damaged property while the repair bidder simultaneously also registers as a salvage bidder to bid to purchase the damaged property. For example, a ship yard may bid to repair a damaged vessel, but if the ship yard determines that the repair bids are too high, the ship yard may bid to purchase the damaged vessel so that it may repair and resell the vessel. It can happen since the ship yard may be open to repair and if the bids to repair are too high that ship yard may want to buy and then repair and then resell the vessel.

In addition to bids for repair and salvage of damaged property, the system and methods described herein may also be used to solicit bids for restoration projects, demolition projects, renovation projects (e.g., renovation of school buildings or other government property before or after buying or leasing the property), and moving and transportation projects (e.g., the transport of portable class rooms to schools).

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An automated auction system comprising:
a network server communicatively connected to a telecommunications network, the server comprising an electronic procurement auction software program installed thereon to electronically receive a request for proposal (RFP) submitted over the telecommunications network by a requester to solicit a plurality of bids for repair of a damaged property and to electronically receive bids submitted over the telecommunications network by at least one repair bidder, wherein each repair bidder's bid comprises the repair bidder's price to repair the damaged property;
an electronic forward auction software program installed on the server, wherein the server concurrently conducts an electronic procurement auction and an electronic forward auction using the electronic procurement auction software program and electronic forward auction software program installed thereon, and wherein the electronic forward auction software program electronically receives bids submitted over the telecommunications network by a plurality of salvage bidders in response to an offer to sell the damaged property that is electronically submitted over the communications network by the requester; and
software installed on the server for comparing results of the electronic procurement auction and the electronic forward auction to make an automated recommendation that is presented to the requester concerning whether the damaged property is more valuable if repaired or if sold for salvage value.

2. The system of claim 1, wherein the server further comprises an operating software and at least one database accessible via the telecommunications network and comprising data related to the requesters, repair bidders, and salvage bidders.

3. The system of claim 1, wherein the damaged property is a vessel, cargo, house, building, mobile home, crane, a rock crusher, water and sewage treatment plant, or any other real or personal property that can be repaired if damaged.

4. The system of claim 1, wherein the system further comprises:
(a) a database installed on the server and accessible via the telecommunications network, wherein the database comprises information related to each category of services offered or desired by registered network members of the system, wherein the registered network members of the system comprise requesters, repair bidders, and salvage bidders;
(b) graphic upload software installed on the server and accessible via the telecommunications network for remote use by requesters to particularly illustrate and explain desired RFP requirements;
(c) software enabling network buyers to generate said RFP for services, wherein said software is installed on the server and accessible via the telecommunications network, the software further comprising a preview module for use during an RFP pending period preceding an active RFP allowing RFPs to be previewed by requesters, wherein each RFP comprises at least one uploaded image and alpha-numeric data;
(d) software for transmitting said RFPs to said server via the telecommunications network;
(e) software for e-mail and wireless distribution via the telecommunications network of RFP notices to those bidders that have asked for notices within selectable categories of RFPs;
(f) software for enabling a bidder to submit an encrypted bid via the telecommunications network to said server; and
(g) software for displaying all bids and a bidder's optional profile to the requester via the telecommunications network, at a time only after an RFP period has closed, so that a successful bidder may be selected.

5. The system of claim 1, wherein the requester's RFP comprises a first narrative description of property damage and the requester's recommended repairs, and wherein the repair bidder's bid in response to the RFP comprises a second narrative description of the repair bidder's recommended repairs if the repair bidder's recommended repairs differ from the requester's recommended repairs.

6. The system as recited in claim 4, wherein the server further comprises:
software for providing a link to a repair bidder's website, which link is provided with the repair bidder's bid.

7. The system as recited in claim 4, wherein the server further comprises:
software for furnishing a particular form to a requester via the telecommunications network for use with a particular category of RFP.

8. The system as recited in claim 1, wherein the RFP requests data from each repair bidder comprising at least one type of data selected from the group consisting of:
a written description of property damage, a visual description of property damage, an insurance assessment, a surveyor report, storage costs, repair costs, ship repairs legal liability insurance (“SRLLI”) costs, time to complete the job, sales tax, percentage of total repair for expected supplement, salvage value, property transportation costs, warranty work estimates, salvage value of items, expected weather days, and union strike information.

9. The system as recited in claim 4, wherein the server further comprises:
software for establishing a member profile through use of a registration questionnaire wherein member profile information is stored in the at least one database, wherein the software for establishing a member profile, the registration questionnaire, and the database are accessible on the server via the telecommunications network.

10. The system as recited in claim 4, in which the requester comprises a member selected from the group consisting of: marine insurance companies, private boat owners, self-insured parties, boat manufacturers, marinas, private and commercial waterfront facilities, homeowners, building owners, mobile home owners, insurers, government agencies, and owners or lessees of any property that is capable of being repaired if damaged.

11. The system as recited in claim 4, in which the repair bidder comprises a member selected from the group consisting of: boat yards, boat and broker-dealers, vessel trailer manufacturers, vessel towing companies, vessel and cargo salvors, vessel transporting companies, salvors and wreck removers, dock and seawall companies, beach dredging and restoration companies, construction contractors, demolition contractors, mechanics, repair companies, and any other contractor capable of repairing or salvaging damaged property.

12. The system as recited in claim 4, wherein the server further comprises:
software for charging commissions to requesters for a lowest RFP type bid even if such lowest bid is not selected by said requester.

13. The system as recited in claim 4, wherein the server further comprises:
software for defining an auction period during which a RFP subject description may be added to, but not deleted, from the database stored on the server and accessible via the telecommunications network.

14. The system as recited in claim 4, wherein the server further comprises:
software for providing selectable categories of sub-contractor databases comprising information related to network members for use in responding to active RFPs.

15. The system as recited in claim 1, wherein the system further comprises: a repair job fragmentation software module, a warranty segregation software module, a repair segregation software module to separate bidding for repairs not covered by insurance from those covered by insurance, industry-specific software information submission templates, a bid-conflict identification and resolution software module, a cost overrun identification software module, a bidder feedback compilation software module, a timing software module, a pre-assigned bid amount software module, and a proxy bidding software module, wherein these software modules and templates are installed on the server and accessible to requesters and bidders by computer using the system via the telecommunications network.

16. The system as recited in claim 4, wherein the server further comprises:
software for establishing a limited RFP auction comprising a selectable subset of repair bidders.

17. The system as recited in claim 16, wherein the server further comprises:
database search software, accessible via the telecommunications network, for identifying candidate bidders for said limited auction.

18. A method comprising the steps of:
(a) submitting to a computer system over a network a request for proposal (RFP) related to a cost to repair a damaged property, wherein the RFP is submitted by a requester;
(b) soliciting bids electronically for repair of the damaged property using the computer system to conduct an automated electronic procurement auction that solicits bids, wherein the bids are solicited from repair bidders in response to the RFP for repair of the damaged property;
(c) electronically accepting bids submitted electronically by repair bidders to the computer system, each bid comprising the repair bidder's price to repair the damaged property;
(d) soliciting bids electronically for the sale of the damaged property using the computer system to conduct an automated electronic forward auction concurrently with the electronic procurement auction, wherein the electronic forward auction electronically receives salvage bids from salvage bidders through the network so as to permit the requester to offer to sell the damaged property to the salvage bidder submitting a highest salvage bid;
(e) electronically accepting bids submitted electronically to the computer system through the network by salvage bidders who wish to purchase the damaged property; and
(f) electronically compiling the results of the electronic procurement auction and the electronic forward auction for comparison to determine whether the damaged property is more valuable if repaired or if sold for salvage value.

19. The method of claim 18, wherein the method further comprises a step selected from the group consisting of:
(g) using the computer system, selecting a lowest procurement bid submitted by the repair bidders participating in the electronic procurement auction, wherein the lowest procurement bid is less than procurement bids submitted by other repair bidders and a predetermined amount less than the estimated value of the damaged property when repaired minus the highest salvage bid, and wherein the repair bidder submitting the lowest procurement bid is selected to repair the damaged property; and
(h) using the computer system, selecting a highest salvage bid submitted by the salvage bidders participating in the electronic forward auction, wherein the highest salvage bid is greater than salvage bids submitted by other salvage bidders and a predetermined amount more than the estimated value of the damaged property when repaired minus the lowest procurement bid, and wherein the salvage bidder submitting the highest salvage bid is selected to purchase the damaged property.

20. The method of claim 18, wherein the method further comprises the steps of:
(i) using the computer system, electronically submitting through the network a first narrative description of property damage and the requester's recommended repairs in the requester's RFP; and
(j) using the computer system, electronically submitting through the network a second narrative description of the repair bidder's recommended repairs in the repair bidder's bid in response to the RFP if the repair bidder's recommended repairs differ from the requester's recommended repairs.
